(19) United States
(12) Patent Application Publication
(10) Pub. No.: US 2016/0274556 A1
(43) Pub. Date: Sep. 22, 2016

(54) SYSTEMS AND METHODS FOR MONITORING AND CONTROL OF ENERGY CONSUMPTION SYSTEMS

(71) Applicant: Michael D. Murphy, Newport Beach, CA (US)

(72) Inventor: Michael D. Murphy, Newport Beach, CA (US)

(21) Appl. No.: 14/664,693

(22) Filed: Mar. 20, 2015

(51) Int. Cl. G05B 19/048; G05B 19/10

(52) U.S. Cl. CPC G05B 19/048; G05B 19/106; G05B 2219/2639

(57) ABSTRACT

Systems and methods are provided for monitoring and managing energy consumption for a managed facility. The managed facility may include one or more electronic devices such as appliances or other smaller electronics that consume energy when operated. A hub at the managed facility may receive energy usage information for the managed facility and provide the energy usage information to a server. The server may generate, based on the energy usage information, instructions for controlling some or all of the one or more electronic devices. The instructions may be generated based on additional information such as user preferences or rules, utility alerts, facility occupancy, energy demand, or other information. The hub may receive the instructions and provide corresponding control signals to the electronic devices to operate the devices to manage the energy consumption.

### BACKGROUND

This invention relates generally to energy conservation systems and, more particularly, to networked systems for monitoring and control of energy consumption systems.

Various facilities such as homes, businesses, factories, buildings, and other facilities include energy consuming devices. Energy consuming devices may include appliances such as refrigerators, washing machines, dryers, and dishwashers. Energy consuming devices may include larger systems such as heating, ventilation, and air conditioning (HVAC) systems and/or various components thereof such as heaters, fans, and air conditioners. Energy consuming devices may include smaller electronic devices such as televisions, computers, coffee makers, digital video recorders, cable boxes, and light sources such as light bulbs.

It can be challenging to operate the various energy consuming devices at a facility in a way that meets the needs of the occupants and users of the facility without consuming large amounts of energy. If care is not taken, energy can be wasted which can be undesirably costly and can waste resources that could be used for important operations at other facilities.

It would therefore be desirable to be able to provide improved systems for monitoring and control of energy consumption systems.

### SUMMARY

In accordance with various embodiments, systems and methods are provided for monitoring and control of energy consumption systems.

In accordance with an embodiment, a system is provided that includes hub computing equipment at a managed facility that includes at least one electronic device, where the hub computing equipment includes processing circuitry configured to generate control signals for operating the at least one electronic device; and a server that includes processing circuitry configured to: receive energy usage information for the managed facility from the hub computing equipment; extract device usage information for the at least one electronic device from the received energy usage information; generate instructions for operating the at least one electronic device based on the extracted device usage information; and provide the generated instructions to the hub computing equipment.

In accordance with another embodiment, a method is provided that includes, with hub computing equipment at a managed facility that includes at least one electronic device, generating control signals for operating the at least one electronic device; with a server in communication with the hub computing equipment, receiving energy usage information for the managed facility from the hub; with the server, extracting device usage information for the at least one electronic device from the received energy usage information; with the server, generating instructions for operating the at least one electronic device based on the extracted device usage information; and, with the server, providing the generated instructions to the hub computing equipment.

In accordance with another embodiment, a system is provide that includes a managed facility having one or more energy consuming devices; hub computing equipment at the managed facility configured to generate control signals for operating the one or more energy consuming devices; and a server that includes processing circuitry configured to: receive energy usage information for the managed facility from the hub computing equipment; extract device usage information for the one or more energy consuming devices from the received energy usage information; generate instructions for operating the one or more energy consuming devices based on the extracted device usage information; and provide the generated instructions to the hub computing equipment.

In accordance with another embodiment, a method is provided that includes providing a facility management application to a user of a user device with a processor of the user device; receiving, with the facility management application, a request to automate facility management operations for a managed facility; providing, with the facility management application, a plurality of automation options to the user, where the automation options each include at least one trigger, and at least one action associated with the at least one trigger; receiving, with the facility management application, selected ones of the plurality of automation options from the user; storing, with a memory of a server, the selected ones of the plurality of automation options from the user; and operating, with a hub at the managed facility and based on the stored selected ones of the plurality of automation options from the user, one or more devices at the managed facility.

Further features of the present invention, its nature and various advantages will be more apparent from the accompanying drawings and the following detailed description of the preferred embodiments.

### BRIEF DESCRIPTION OF THE DRAWINGS

FIG. 1 is a diagram of an illustrative system for monitoring and control of energy consumption for a managed facility in accordance with an embodiment.

FIG. 2 is a diagram of an illustrative hub in accordance with an embodiment.

FIG. 3 is a diagram of an illustrative managed facility in accordance with an embodiment.

FIG. 4 is a flow chart of illustrative steps that may be used in monitoring and controlling energy consumption for a managed facility in accordance with an embodiment.

FIG. 5 is a flow chart of illustrative steps that may be used in extracting device usage information from energy consumption information in accordance with an embodiment.

FIG. 6 is a flow chart of illustrative steps that may be used in modifying device operations based on extracted usage information in accordance with an embodiment.

FIG. 7 is a flow chart of illustrative steps that may be used in modifying HVAC device operations based on extracted usage information in accordance with an embodiment.

FIG. 8 is a flow chart of illustrative steps that may be used in modifying device operations for various types of devices based on extracted usage information in accordance with an embodiment.

FIG. 9 is a flow chart of illustrative steps that may be used in modifying device operations based on cost information in accordance with an embodiment.

FIG. 10 is a diagram of an illustrative user device showing a user interface screen for facilitation of user access and control of a monitoring and control system for a managed facility in accordance with an embodiment.

FIG. 11 is a diagram of an illustrative user device showing an energy monitoring and control user interface screen in accordance with an embodiment.

FIG. 12 is a diagram of an illustrative user device showing an energy monitoring and control user interface screen including user rules in accordance with an embodiment.

FIG. 13 is a diagram of an illustrative user device showing an energy monitoring and control user interface screen showing energy consumption and production information in accordance with an embodiment.

FIG. 14 is a diagram of an illustrative user device showing a climate control user interface screen including climate control events in accordance with an embodiment.

FIG. 15 is a diagram of an illustrative user device showing a climate control user interface screen including user climate controls in accordance with an embodiment.

FIG. 16 is a diagram of an illustrative user device showing a people monitoring user interface screen showing users located at a managed facility in accordance with an embodiment.

FIG. 17 is a diagram of an illustrative user device showing a people monitoring user interface screen showing the location of a user away from a managed facility in accordance with an embodiment.

FIG. 18 is a diagram of an illustrative user device showing a security control user interface screen including user rules in accordance with an embodiment.

FIG. 19 is a diagram of an illustrative user device showing a camera monitoring and control user interface screen in accordance with an embodiment.

FIG. 20 is a diagram of an illustrative user device showing a camera monitoring and control user interface screen showing motion events in accordance with an embodiment.

FIG. 21 is a diagram of an illustrative user device showing an access control user interface screen for providing user control of access to a managed facility in accordance with an embodiment.

FIG. 22 is a diagram of an illustrative user device showing an access control user interface screen with door lock user controls in accordance with an embodiment.

FIG. 23 is a flow chart of illustrative steps that may be used in operating a system for monitoring and control of energy consumption in a learning mode in accordance with an embodiment.

FIG. 24 is a flow chart of illustrative steps that may be used for in-application automation of a system for monitoring and control of energy consumption in a learning mode in accordance with an embodiment.

FIG. 25 is a diagram of an illustrative user device showing a user interface screen in which a setup button has been selected by the user in accordance with an embodiment.

FIG. 26 is a diagram of an illustrative user device showing a user interface screen in which an automation button has been selected by the user to initiate in-application automation operations in accordance with an embodiment.

### DETAILED DESCRIPTION

The present invention relates generally to systems and methods for energy conservation and, more particularly, to systems and methods for monitoring and control of energy consuming systems.

The system may include hub computing equipment at a managed facility and additional computing equipment such as a remote server in communication with the hub. The hub may receive energy consumption information from a meter at the managed facility and/or from one or more individual monitoring components associated with individual electronic devices. The hub may provide the energy consumption information to a remote server. The remote server may extract device usage information from the energy consumption information and, based on the extracted information and/or other information such as user rules and preferences, utility alerts, rate information and cost information, facility occupancy information and/or other information, generate instructions for operating energy consuming devices at the facility to reduce the overall energy usage at the facility while meeting the needs and desires of the occupants and/or users of the facility.

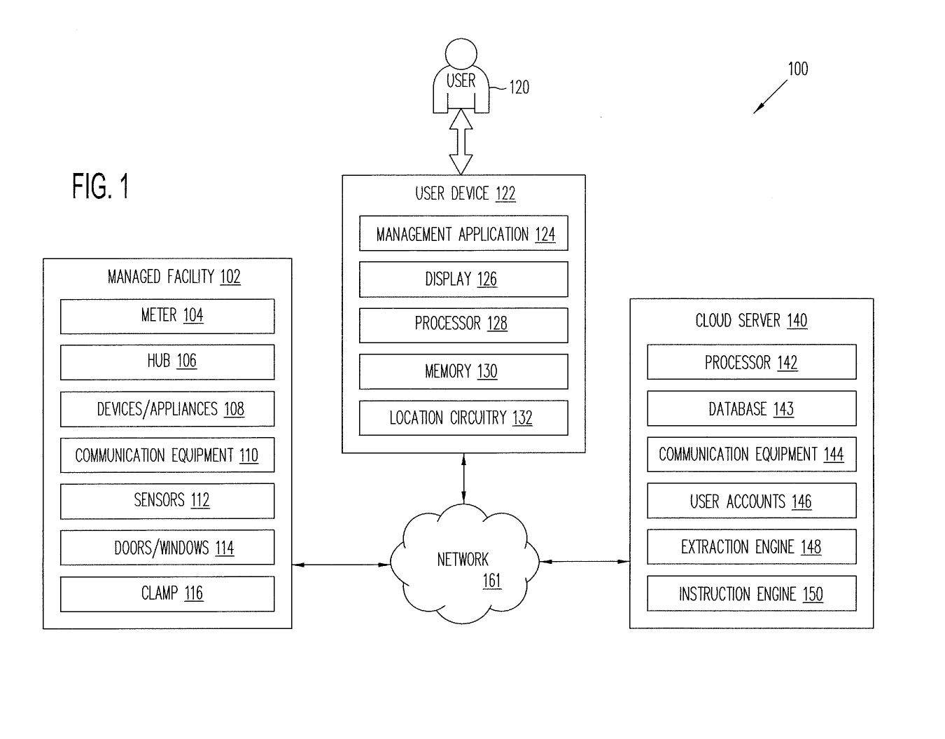

An illustrative monitoring and control system 100 is shown in FIG. 1. As shown in FIG. 1, system 100 may include hub computing equipment such as hub 106 located at a managed facility 102. Hub 106 may communicate with a remote server such as cloud server 140 and/or a user device such as user device 122 via a network such as network 161. Network 161 may represent the internet, a local area network, a cellular data network, or combination of suitable networks for facilitating communication between user device 122, server 140, and facility 102 (e.g., hub 106).

Hub 106 may receive and capture energy consumption information from a meter 104, a clamp 116 (e.g., a current transformer (CT) clamp) on meter 104, one or more sensors 112, and/or one or more devices/appliances 108 located in or around the managed facility. Energy consumption information received by hub 106 may be provided to cloud server 140 and/or user device 122. The energy consumption information may include a gross energy usage feed from meter 104 and/or individual device usage information received from associated device monitors for the individual devices (e.g., internal or external energy monitors for each device).

Cloud server 140 may receive the energy consumption information (e.g., using communications equipment 144) and extract (e.g., using an extraction engine such as extraction engine 148) device and/or appliance usage information from the energy consumption information. For example, the processing equipment such as processor 142 of server 140 may remove individual device usage information from the gross energy feed and, based on known, provided, or learned usage signatures in the remaining gross energy feed, determine usage information (e.g., time, duration, and consumption information) for each of the devices and/or appliances at the managed facility.

Processor 142 may determine, based on the gross energy feed, a total energy usage determined from the gross energy feed, the extracted and/or additional information, that energy usage at the managed facility 102 should be increased or decreased (e.g., the overall energy usage and/or individual device and/or appliance usage). Server 140 may generate instructions (e.g., using instruction engine 150) for modifying the operation of one or more devices and/or appliances at facility 102 and may provide the generated instructions to hub 106. Hub 106 may receive the instructions from server 140 and may translate the instructions into one or more appropriate communications protocols for operating the one or more devices and/or appliances.

Hub 106 may provide translated instructions to each device and/or appliance to modify the operation of that device and/or appliance according to the instructions from server 140. For example, hub 106 may reduce or increase the intensity of one or more light sources (e.g., light bulbs), cycle one or more components of an HVAC system, decrease or increase the water temperature of a water heater, swimming pool, or hot tub, turn on or turn off a swimming pool pump, or prevent or initiate startup of one or more appliances (as examples) based on the instructions from server 140. In this way, server 140 and hub 106 may cooperate to manage energy usage at managed facility 102 (e.g., hub computing equipment and the server may be configured to cooperate to manage total energy consumption by the managed facility by controlling operation of the plurality of appliances and other devices based on the energy usage information received by the hub from a meter at the managed facility). In some embodiments, server 140 and hub 106 may cooperate to manage other aspects of facility 102 such as access to the facility (e.g., by controlling locking, unlocking, closing, and/or opening of doors/windows 114) and/or monitoring human and/or communications traffic in and out of facility 102.

Server 140 may generate the instructions based on additional information such as information received from user device 122. For example, a user such as user 120 may use a facility management application such as management application 124 running on user device 122 (e.g., based on instructions stored in memory 130 and executed by processor 128) to input facility management preferences, rules, and custom automations to be used by server 140 for generating instructions for modifying the operation of one or more devices and/or appliances at one or more managed facilities such as facility 102. A user interface for application 124 may be provided to user 120 using input-output components of user device 122 such as display 126 (e.g., a touchscreen display or other non-touch display). User device 122 may include location circuitry 132 (e.g., global positioning system (GPS) circuitry) that is configured to provide the location of user device 122 (e.g., to server 140 for location-based functions for managing system 100).

Server 140 may include a database 143 that stores information associated with one or more user accounts 146. Each user account may include stored user preferences, user rules, device priority information, user feedback information, and/or other information associated with each user. User information stored in association with user accounts 146 may be used by, for example, extraction engine 148 and/or instruction engine 150 in determining energy usage at one or more facilities of the user and generating instructions for operating devices/appliances at the facilities for managing energy usage, security, access, or other aspects of the managed facilities.

Meter 104 of managed facility 102 may, for example, be an electrical meter on a main electrical line for the facility (e.g., an electrical meter that monitors consumption of electric energy at the facility and/or communicates consumption information to a utility). Meter 104 may include other meters such as gas meter or an energy production meter (for facilities with solar or other energy production equipment).

Sensors 112 may include environmental sensors such as thermometers, humidity sensors, barometers, light sensors, etc. and/or may include individual device usage sensors such as an electrical monitor interposed between a wall outlet and a plug of an electronic device (e.g., a television, a digital video recorder, a coffee maker, a refrigerator, a washing machine, a dishwasher, etc.) or an internal electrical monitor of the electrical device.

Devices/appliances 108 and/or doors/windows 114 may be configured to be remotely controlled or operated based on communications received using various particular communications protocols. Hub 106 may include and/or may be configured to receive communications circuitry for communicating with various devices/appliances using the appropriate communications protocol for that device.

Facility 102 may include communication equipment 110 (e.g., one or more routers, modems, landlines, cable lines, or other communications equipment for communicating over network 161). Hub 106 may include additional communications equipment for communicating over network 161 and with devices/appliances 108, sensor 112, and/or doors/windows 114. Hub 106 may include communications circuitry for communicating directly with user device 122 in some embodiments. Hub 106 may utilize communication equipment 110 or may communicate separately from communication equipment 110. Hub 106 may receive communications information from communication equipment 110 and/or one or more user devices 122 and may monitor the communications, facility occupancy, and/or user locations using the received communications information.

User device 122 may include one or more personal computers, workstations, portable computers, mobile phones, personal data assistants, wearable computing devices, etc. Memory 130 may include hard drives, volatile memory, non-volatile memory, and/or other storage media or non-transitory computer-readable media including contents that can be executed by processor 128.

Server 140 may include one or more personal computers, workstations, computers configured as servers, mainframe computers, portable computers, etc. Memory 143 may include hard drives, volatile memory, non-volatile memory, and/or other storage media or non-transitory computer-readable media including contents that can be executed by processor 142.

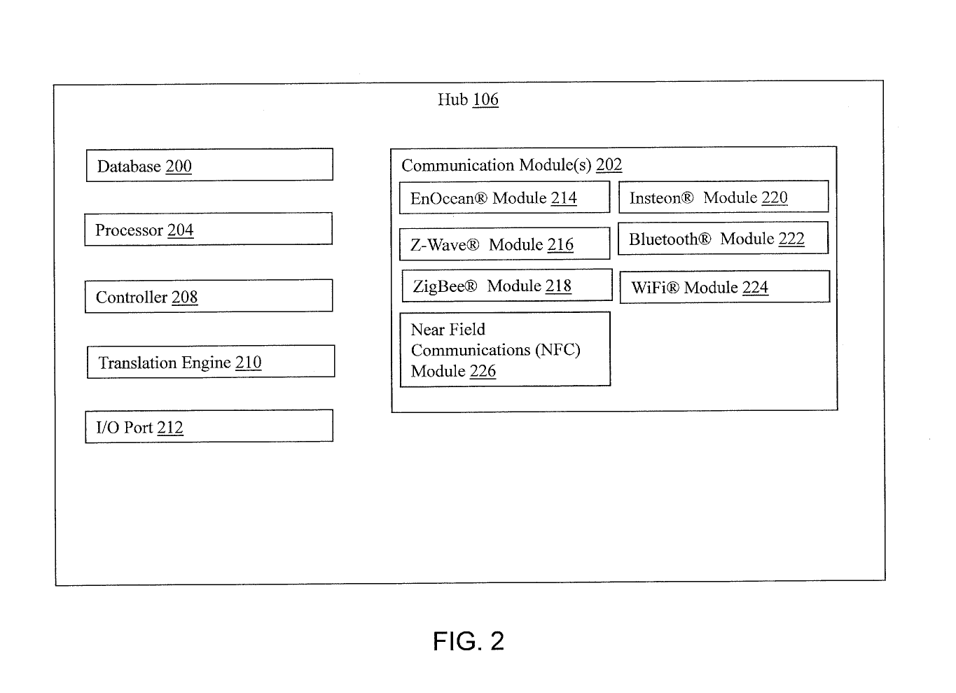

FIG. 2 shows a block diagram of an illustrative hub 106. As shown in FIG. 2, Hub 106 may include processing circuitry such as processor 204, memory such as database 200, control circuitry such as controller 208, translation circuitry such as translation engine 210, input/output components such as input/output (I/O) port 212, and communications module(s) 202.

Database 200 may include hard drives, volatile memory, non-volatile memory, and/or other storage media or non-transitory computer-readable media including contents that can be executed by processor 204. Translation engine 210 may be configured to receive instructions from server 140 (FIG. 1) and translate the received instructions into instructions using various communications protocols specific to various individual devices and/or appliances to be controlled. Controller 208 may provide the translated instructions to a corresponding communications module for transmission to the device and/or appliance. Translation engine 210 and/or controller 208 may each be implemented using dedicated circuitry and/or implemented as software stored by database 200 and executed by processor 204.

As shown in FIG. 2, communication module(s) 202 of hub 106 may include various communication modules specific to various communications protocols such as EnOcean® module 214, Z-Wave® module 216, ZigBee® module 218, Insteon® module 220, Bluetooth® module 222, WiFi® module 224, and near field communications (NFC) module 226. Each communication module may send and receive information and/or instructions to one or more devices or appliances at managed facility 102 having corresponding communications circuitry.

One or more modules of communication module(s) 202 may be integrally formed (e.g., within a housing 250 of hub 106) or may include a separate module that can be installed (e.g., plugged into) hub 106 to provide communications functionality for a communications protocol specific to that module. I/O port 212 may be configured to receive external communication modules supported by software stored by database 200 for communication with one or more devices and/or appliances at facility 102. In some embodiments, I/O port 212 may be used to couple hub 106 to other computing equipment such as user device 122 (e.g., for software or firmware upgrades or to download energy data stored in database 200). In other embodiments, software or firmware upgrades and/or data downloads for hub 106 may be performed using wired or wireless communications circuitry of hub 106 such as one or more of module(s) 202 in communication with server 140.

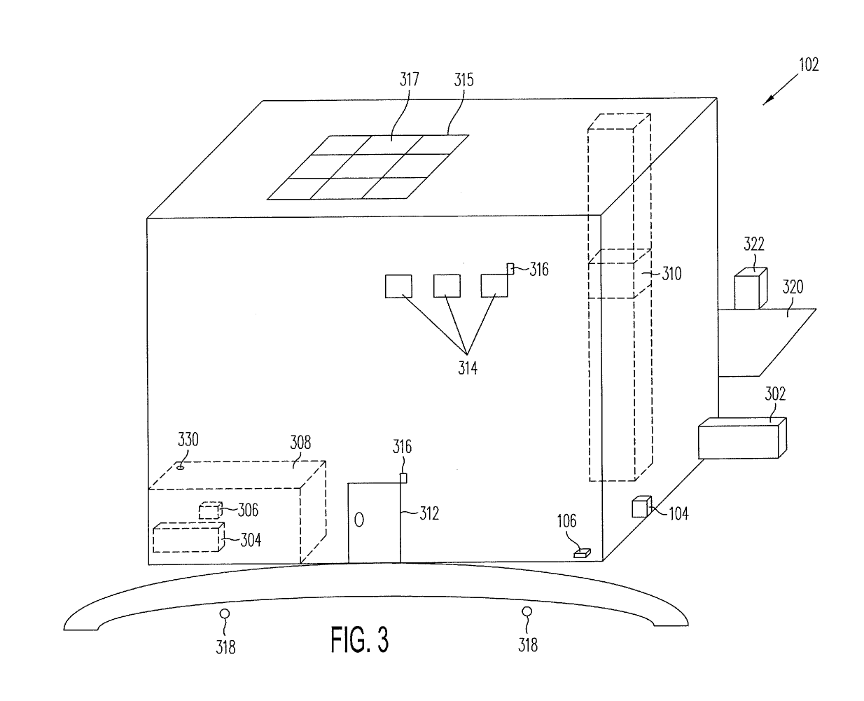

FIG. 3 is a diagram of an illustrative managed facility 102. Managed facility 102 may be, as examples, a home, a business, a factory, a hospital, an airport, a warehouse, a building such as an office building, a hotel, an arena, a stadium, a golf course, or any other facility or location at which energy, and particularly electrical energy, is consumed by one or more devices and/or appliances.

As shown in FIG. 3, managed facility 102 may include devices/appliances such as an HVAC system 302 (e.g., a system including one or more air conditioning units, heating units, fans, pumps, etc.), one or more devices/appliances 304 located in various rooms or sections or zones 308 of facility 102, one or more monitors 306 for some or all of the devices/appliances 304, one or more doors 312 and windows 314, an elevator 310, one or more cameras 330, a sprinkler system 318, water management equipment 322 such as a pump and/or a heater for a body of water 320 (e.g., a hot tub, a swimming pool, or a pond) and one or more meters such as meter 104 that provides gross energy consumption information for the facility. Facility 102 may also include energy generating equipment 315 such as one or more solar panels 317 that generate energy for facility 102 and/or provide energy to a utility if the energy is not used at facility 102.

One or more clamps (not shown) may be installed at or near meter 104 or coupled to meter 104 for extracting energy consumption information for facility 102 and providing the energy consumption information to hub 106. Hub 106 may also receive energy consumption and/or other usage information for individual devices/appliances from, for example, an energy monitor 306 installed at or integrally formed with each individual device/appliance. As noted above, hub 106 may provide the received energy consumption information (e.g., a gross energy usage feed for facility 102 and/or individual device usage information) and may provide some or all of the received energy consumption information to server 140 (FIG. 1).

Hub 106 may receive instructions generated by server 140 based on the provided energy consumption information and/or other information and may operate any or all of the devices/appliances at or around facility 102 responsive to the received instructions. As shown in FIG. 3, facility 102 may include control components 316 coupled to one or more openings in facility 102 such as windows 314, doors 312 and/or other openings such as gates, vents, or the like.

Control components 316 may be mechanical and/or electronic (e.g., magnetic) access control components that are operable (e.g., by hub 106) to lock, unlock, open, and/or close the openings in facility 102 (e.g., based on timed rules, authorized user detection, and/or remote instructions such as instructions generated by a user with a user device and communicated to hub 106 via server 140).

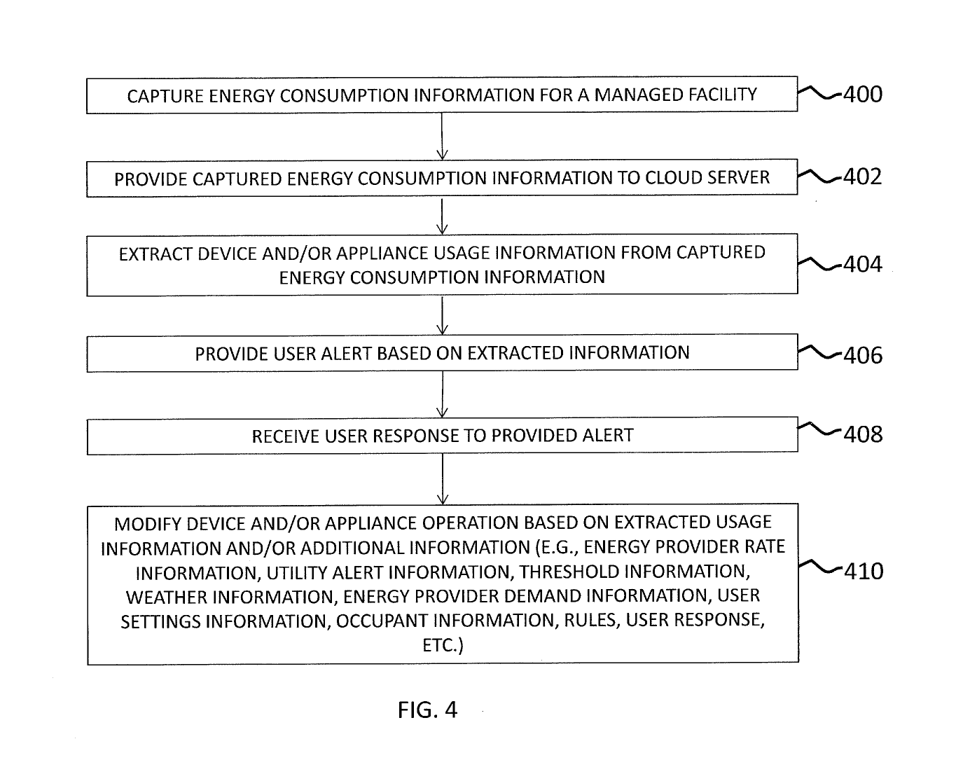

Illustrative operations that may be performed for monitoring and controlling energy consumption for a facility such as facility 102 are shown in FIG. 4 according to an embodiment.

At block 400, energy consumption information for a managed facility may be captured. For example, hub computing equipment at the managed facility may, alone or in cooperation with one or more clamps, capture gross energy usage information from a meter at the facility. The hub computing equipment may also or alternatively capture individual device usage information (e.g., from individual device monitors).

At block 402, captured energy consumption information may be provided to a cloud server (e.g., by the hub computing equipment over a network).

At block 404, device and/or appliance usage information may be extracted from the captured energy consumption information. For example, computing equipment such as processing circuitry at the server may determine energy consumption, power on, power off, and/or other usage information for one or more individual appliances and/or devices based on modulations in the gross energy consumption feed that are specific to the operation of those individual devices/appliance (or groups of devices/appliances).

At block 406, in some embodiments, a user alert may be optionally be provided to a user (e.g., to a user device) based on the extracted information. In one example, the user alert may be a high energy usage state alert to the user that energy usage at the managed facility is high (e.g., above a static or dynamic threshold based on utility demand) and action should be taken. Recommended actions and/or notifications of automated actions may be included in the user alert. In another example, the user alert may include a request for information. For example, in a learning mode (e.g., shortly after installation of hub 106 at facility 102), an energy usage change may be detected in connection with a detected operation of a device and the user may be queried to provide information about the device.

At block 408, a user response to the provided alert may be received. For example, the user response may include instructions for energy reduction operations, instructions to lock, unlock, open, or close a door or window, or permission to take a proposed action in the alert. In another example, the user response may include feedback regarding the detected usage change.

At block 410, the operation of one or more devices and/or appliances may be modified (e.g., powered off, powered on, reduced in power, increased in power, cycled, etc.) based on the extracted usage information and/or additional information. The additional information may include energy provider rate information, utility alert information (e.g., a high demand alert from a utility provider or a low demand alert from the utility provider), threshold information (e.g., a rate threshold, a cost threshold, an overall usage threshold for a facility and/or usage thresholds for individual devices/appliances), weather information (e.g., an outside temperature and/or precipitation information), energy provider demand information, user settings information (e.g., user-defined automation settings/rules for one or more devices/appliances or user-defined device/appliance priorities), occupant information (e.g., information indicating a number of occupants at the facility and/or the identity of the occupants), other rules (e.g., user access rules, or rules preventing operation of multiple high demand appliances during a common time period), the received user response, etc.

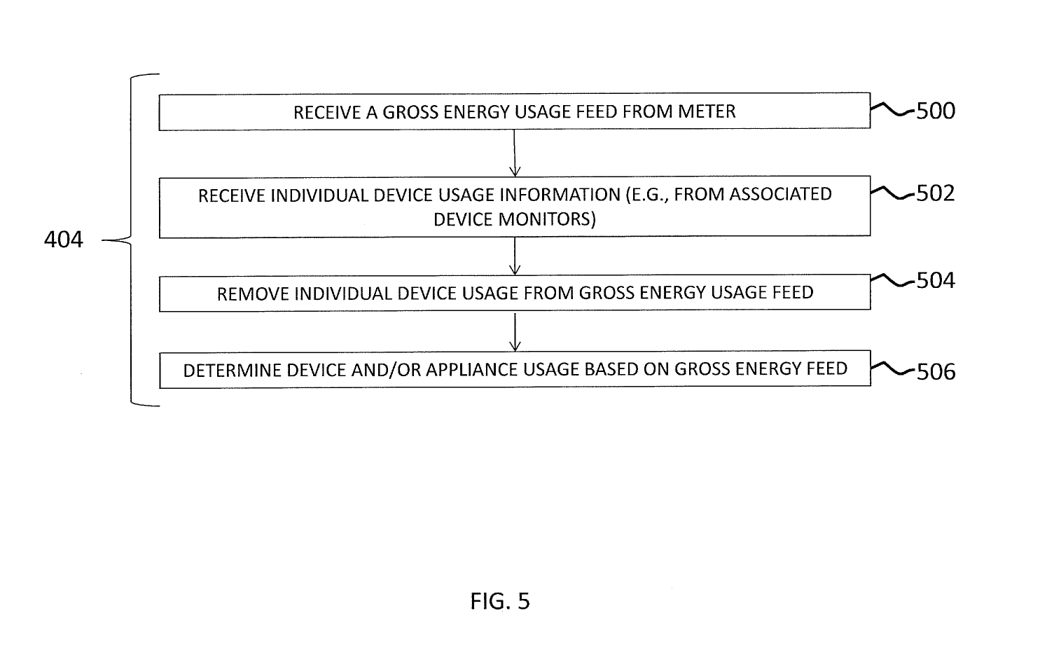

Illustrative operations that may be performed for extracting device and/or appliance usage information from captured energy consumption information as described above in connection with block 404 of FIG. 4 are shown in FIG. 5 according to an embodiment.

At block 500, a gross energy usage feed may be received from, for example, a meter at the managed facility at, for example, a hub at the facility.

At block 502, individual device usage information may be received at the hub. The individual device usage information for one or more individual devices/appliances may, for example, be received from associated device monitors for the individual devices (and/or appliances). Individual device usage information may also be learned (e.g., by hub 106 and/or server 140) for a device that does not report its energy and that has no external monitors. Hub 106 may sample energy usage at facility 102 at a relatively high sampling rate (e.g., reading energy usage at the millisecond level). Because of this relatively high sampling rate, the hub, while in learning mode, may separate and identify energy usage signatures for each of the energy consuming devices in a facility. In order to identify which device corresponds to an identified signature, in some embodiments, hub 106 may poll the user to report the operation of a device (e.g., switching on or off of a light or an appliance) in at the time the signature was detected. In this way, individual device usage information can be identified even if the device can not report any type information to the hub such as energy usage or current status.

Hub 106 and/or server 140 may learn and identify the signatures of various device over time (e.g., over a period of 30 days) by slowly polling the user so as to not inundate them or the learning may be performed rapidly in a specific mode designed to allow the user to quickly pole all of the devices in a room, section of a facility or the entire facility, one device after another, by responding to the detected energy change while turning on or off or plugging in or unplugging any energy consuming device or group of devices (such as groups of lighting controlled by one switch, or groups of entertainment equipment) and requesting specific information about the detected device (such as a friendly name, a location, a zone, a group, a wattage, quantity, a manufacture, an expected usage, etc.) and then storing the energy usage detected along with the information collected from the user to and provided to server 140 for later use by the extraction engine.

At block 504, the individual device usage information may be removed from the gross energy usage feed. For example, usage information for one or more individual devices/appliances (e.g., received usage information from the device/appliance monitors or learned usage signatures in the gross energy consumption feed) may be subtracted from the gross energy feed.

A gross energy feed may include energy consumption information over a period of time and may fluctuate based on which devices/appliances are operated and when. For example, an air conditioner, a water heater, a pool pump, a television, and a coffee maker may all be operated at a particular facility during a partially overlapping time period. An energy monitor on the television may provide usage information for the television to the hub that is then provided to the server. In addition, the system (e.g., the hub and server) may have learned over repeated uses of the coffee maker (e.g., along with feedback information from the user indicating that the coffee maker was operated at various times during a learning phase for the system) that a particular rise and fall in the gross energy feed is characteristic of the coffee maker operation. The particular rise and fall associated with the coffee maker and fluctuations provided by the TV energy monitor may be subtracted from the gross energy feed to remove the effects of known devices.

At block 506, device and/or appliance usage may be determined based on the gross energy feed (e.g., the original gross energy feed or the subtracted gross energy feed with the individual device usage removed). For example, usage signatures (e.g., fluctuations in the energy feed) of various large appliances (e.g., dishwashers, HVAC components, pool pumps, hot water heaters, washing machines, dryers, etc.) may be detected in the gross energy feed and used to determine when each device/appliance was operated and how much energy was consumed by the device/appliance over time.

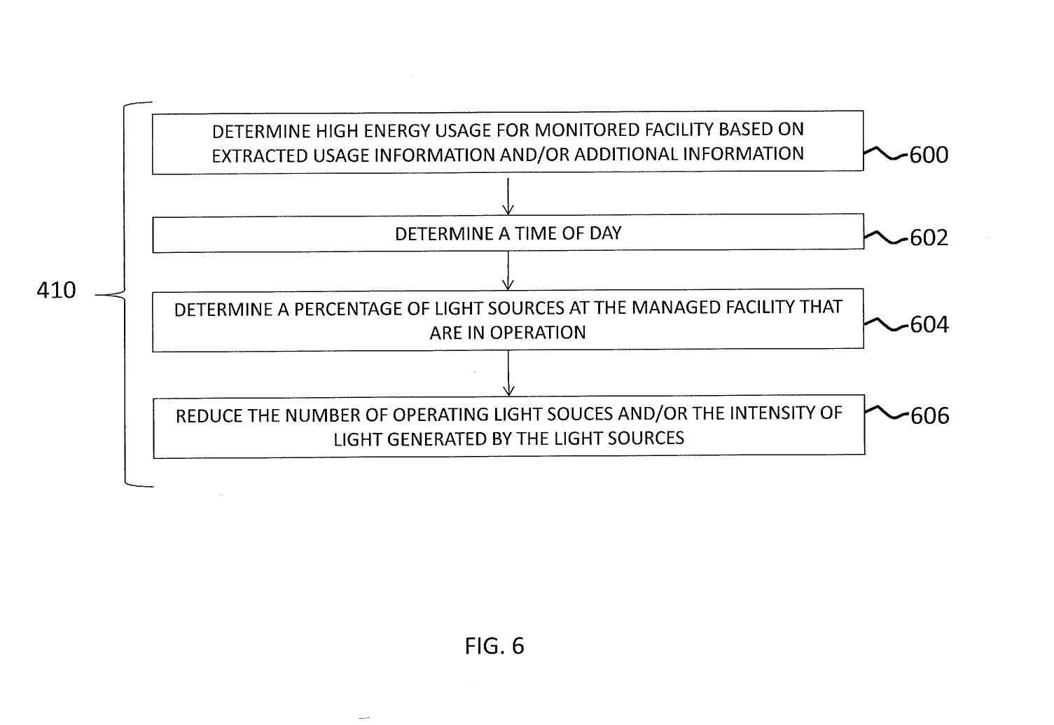

Illustrative operations that may be performed for modifying device and/or appliance operation based on extracted usage information and/or additional information as described above in connection with FIG. 4 are shown in FIG. 6 according to an embodiment.

At block 600, high energy usage (e.g., a high energy usage state) may be determined for a monitored facility based on the extracted usage information and/or the additional information. For example, energy usage over a threshold may be detected. The threshold may be determined based on energy provider demand (e.g., whether a high demand alert has been received), facility occupant information, weather information, user automation settings or other information. For example, a lower energy threshold may be used during moderate weather conditions or when only one occupant is at the facility and a relatively higher energy threshold may be used for extremely hot or cold weather or when multiple occupants are present. The threshold may be lowered during an energy demand alert.

At block 602, a time of day may be determined.

At block 604, a percentage or number of light sources at the managed facility that are in operation may be determined.

At block 606, the number of operating light sources and/or the intensity of light generated by the light sources may be reduced. The reduction in lighting may be performed based on the time of day. For example, if energy is being used for light sources (e.g., light bulbs) during daylight hours, the light sources may be turned off. If energy is being used for light sources during night hours, the lighting may be reduced by a predetermined percentage (e.g., reduced to between 50% and 70% of the current energy usage) by turning off one or more light sources (e.g., in a room that is unoccupied) and/or reducing power to one or more light sources.

Reducing power to one or more light sources may be performed at a relatively slow reduction rate that is difficult or impossible for a typical person to detect. For example, a light bulb may be reduced from 100% power to 60% power over a period of one minute, five minutes, ten minutes, or 30 seconds (as examples) to prevent the occupants from noticing the change. In this way, energy can be conserved while meeting the lighting needs of the facility occupants.

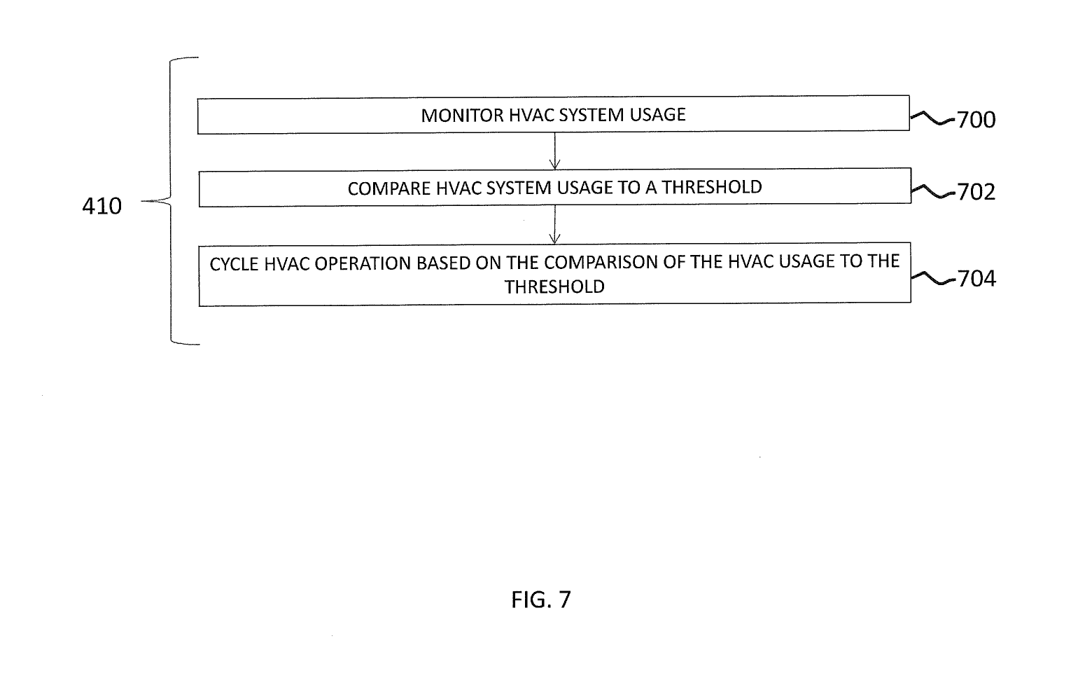

Illustrative operations that may be performed for modifying device and/or appliance operation based on extracted usage information and/or additional information as described above in connection with FIG. 4 are shown in FIG. 7 according to another embodiment.

At block 700, HVAC system usage at a facility may be monitored. For example, by providing, with a hub, a gross energy feed to a remote server, the server can monitor, using the gross energy feed, the operation of the HVAC system and its components relative to the overall energy usage of the facility and in the context of total demand for the utility provider. In some embodiments, a user device and/or the hub may also or alternatively be used to monitor usage and extract usage information.

At block 702, the HVAC system usage may be compared to a threshold (e.g., a static threshold or a dynamic threshold determined based on additional information such as described above in connection with block 600 of FIG. 6).

At block 704, responsive to determining that the HVAC system usage exceeds the threshold, operation of the HVAC system may be cycled (e.g., some or all of the components of the HVAC system may be periodically turned on and off) based on the comparison of the HVAC usage to the threshold. For example, in a heat or cool mode of the HVAC system, one or more HVAC fans may remain in operation and a heating component or an air conditioning (AC) component may be cycled off for a percentage of time relative to the time of operation in a normal operating mode (e.g., an AC component or a heating component may be powered off 50% of the time compared to normal operation). In various embodiments, the cycling percentages can be adjusted by the user to find a happy medium between user comfort and energy savings or, under a utility alert, the cycling percentages may be fixed at a rate predetermined by agreement between the utility and the user and can be fixed (e.g., prevented from being manually adjusted) until the utility alert ends. In this way, HVAC control of the interior environment can be maintained while reducing the overall energy usage by the HVAC system.

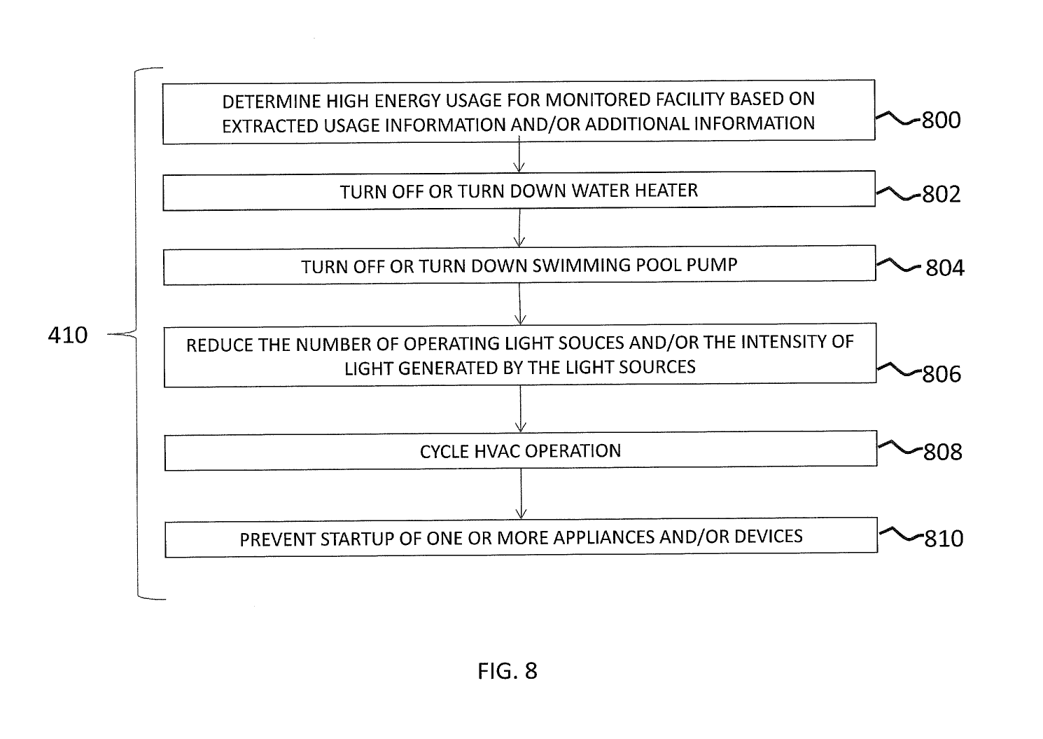

Illustrative operations that may be performed for modifying device and/or appliance operation based on extracted usage information and/or additional information as described above in connection with FIG. 4 are shown in FIG. 8 according to another embodiment.

At block 800, high energy usage may be determined for a monitored facility based on the extracted usage information and/or the additional information as described, for example, above in connection with block 600 of FIG. 6. For example, a utility alert indicating high demand may be received.

At block 802, a water heater at the facility may be turned off or turned down.

At block 804, a swimming pool pump or other control device for body of water may be turned off.

At block 806, the number of operating light sources and/or the intensity of light generated by the light sources may be reduced as described above in connection with block 606 of FIG. 6.

At block 808, operation of one or more HVAC components may be cycled as described above in connection with block 704 of FIG. 7.

At block 810, the startup of one or more appliances or devices may be prevented. For example, a user may, using user device 122 in communication with hub 106 and server 140 (see FIG. 1) set up automatic operation of one or more devices/appliances. In one particular usage scenario, the user may program a dishwasher to start at a first time and a sprinkler system to start at a second time. If the first and/or second times are within the high demand alert period from the utility, the scheduled startup of these devices may be prevented and/or delayed until a the high demand alert is lifter, until a low energy alert is received or a low cost alert is received (as examples).

In another illustrative usage scenario, if a user at a facility attempts to start a washing machine during the utility high demand alert period, a warning may be provided to the user device that startup of that appliance may cause a rate and/or cost spike for the user. Because utilities often determine price rates based on peak usage for a facility, it can be helpful to prevent simultaneous usage of high consumption appliances at the same time, even when no utility alert exists. A user attempting to start a washing machine (for example) while the dishwasher and pool pump are running may also be provided with an alert that a rate hike may result if the washing machine is started now. Options may be provided to the user to cancel startup or to schedule startup of the washing machine when the other high demand appliances turn off.

In various scenarios, any or all of the operations of FIG. 8 may be performed in any suitable order to reduce energy consumption. Additional information may also be used to determine which operations to perform and in which order. For example, HVAC operation may have a higher priority than pool pump operation and the pool pump may therefore be shut down before any modification to the HVAC is performed. In another example, occupant information (e.g., who is at home or how many people are at home or in a given room) and/or occupant condition information (e.g., occupant age, health, heart rate, etc.) may also be used to determine which energy reduction operations to perform and when. For example, in the scenario above in which HVAC systems have a higher priority than pool pump operations, the priority may adjusted depending on the facility occupancy (e.g., the HVAC may have a higher priority when occupancy of the facility is greater than zero and pool pump operations may be prioritized over HVAC operations if the facility is unoccupied so that HVAC operations may be restricted to allow the pool pump to complete operations). As another example, if an elderly resident is at home on a hot day, the resident's heart rate may be monitored (e.g., by a user device such as a wearable device) and used to prevent shut down or cycling of a cooling system based on the age and/or heart rate of the resident. In this way, occupant needs can be met while reducing energy consumption.

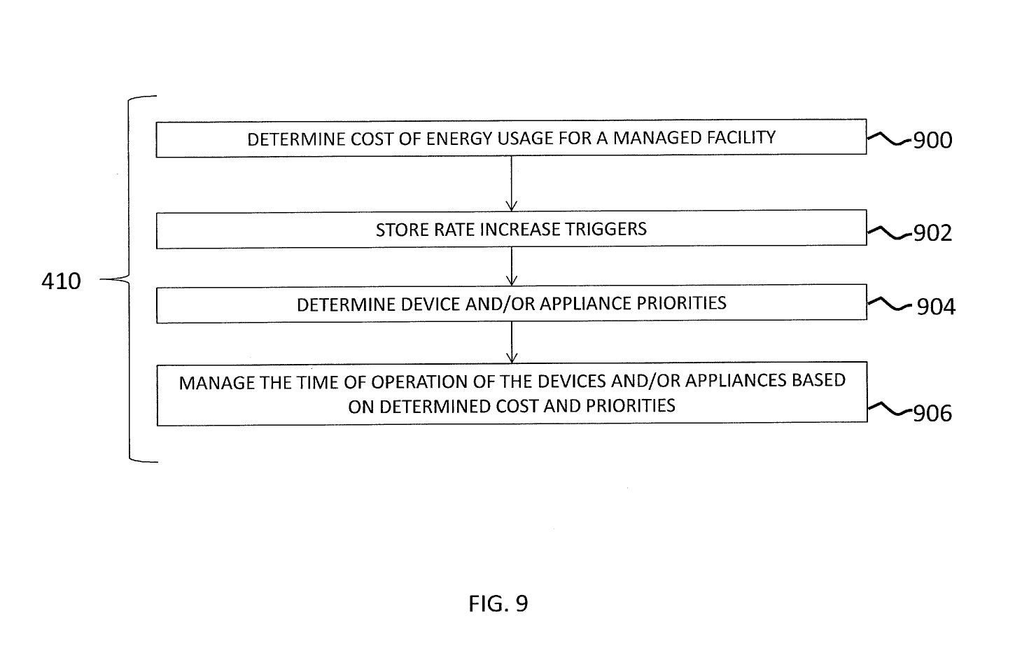

In some scenarios, the actual cost of energy, in addition to or instead of usage information may be used to manage energy consumption for a facility. Illustrative operations that may be performed for modifying device and/or appliance operation based on extracted usage information and/or additional information such as cost information as described above in connection with FIG. 4 are shown in FIG. 9 according to an embodiment.

At block 900, the cost of energy usage for a managed facility may be determined. Determining the cost of energy usage at any given time may include accessing a local or global database of rate information while monitoring energy usage to determine the real time cost of energy usage at a particular facility.

At block 902, one or more rate increase triggers may be stored (e.g., by a server such as server 140 of FIG. 1). Rate increase triggers may be determined based on the rate information database and may include usage levels for particular geographic regions, utility providers, time periods, or other factors that trigger a rate increase for a facility. For example, a particular utility may increase rates for an entire billing period based on a peak usage spike during a short during within the billing period (e.g., if a washing machine, dryer, dishwasher, water heater, air conditioner, and blow dryer are operated at the same time for even a few minutes during a billing month). In this example, a peak usage spike trigger may be stored.

At block 904, device and/or appliance priorities may be determined (e.g., based on user provided priority setting, default settings or system-learned priority settings). For example, the air conditioner may have a higher priority than a blow dryer.

At block 906, the time of operation of the devices and/or appliances may be managed based on determined cost and priorities. For example, because the blow dryer has a lower priority than the air conditioner, the blow dryer may be prevented from operating for one or more minutes (e.g., until one or more other devices/appliances shuts down) to prevent a short-term usage spike that would trigger long-term rate hike.

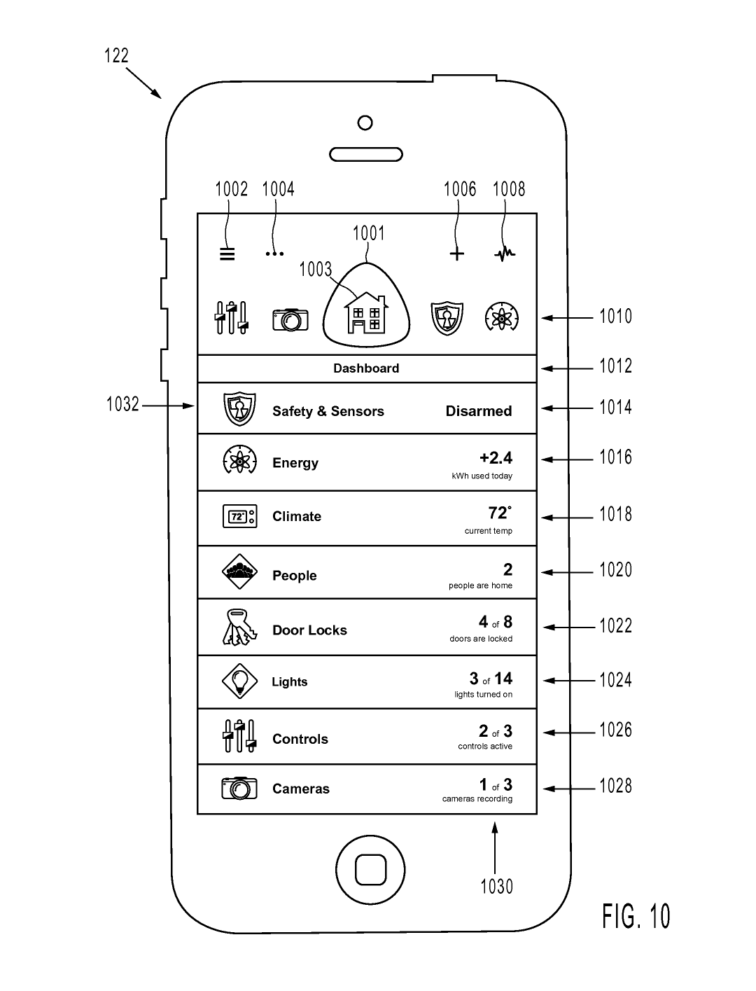

User device 122 of FIG. 1 may include an application such as management application 124 that provides a user of the device with the ability to view and manage any or all controllable and/or monitorable aspects at one or more managed facilities. As shown in FIG. 10, a display 1032 of user device 122 may be used to provide a user interface of a management application, the user interface including a mode indicator 1001 having a mode icon such as home icon 1003. The user interface may also include a menu button 1002, a mood button 1004, a setup button 1006, and a history button 1008. In response to a user tapping menu button 1002, the screen may move to the right to display a sidebar menu (e.g., for switching between users or managed facilities) or signing out of the application. In response to a user tapping mood button 1004, the one or more mood buttons may be provided in which various “moods” (e.g., groups of settings for a particular time of day such as morning, evening, or afternoon or for a particular set of occupants or for a particular occasion) can be selected by the user for the facility devices. For example, a user may generate “movie time” mood in which all the lights in the user's home are dimmed and an entertainment center (e.g., television, digital video recorder, cable box, media player, and sound system) is activated. In another example, a “party time” mood may be generated in which all lights and entertainment devices are powered on.

In response to a user tapping setup button 1006, various setup option buttons may be provided including, for example, an in-app automation button for in-app automation setup for one or more facilities as will be described in further detail hereinafter. Responsive to receiving a user selection of setup button 1006, the user may also be provided with control options for selecting settings for any individual device, sensor, light, etc. and/or any group of devices, sensors, lights, etc. In response to a user tapping history button 1008, the screen may move to the left to display a history screen that shows various events at the facility such as locking or unlocking of doors, changes in energy usage or production, arrival or departure of an occupant, temperature changes, device operations or other events at the facility (e.g., in a timeline).

As shown in FIG. 10, a home screen indicated by home icon 1003 may provide information for various portions of an energy consumption system that can be monitored and controlled. A screen particular to each portion can be accessed by sliding a particular icon in a set of icons 1010 into the mode indicator region 1001 (e.g., a circularly bounded region as in the example of FIG. 10 or another bounded or unbounded region such as region bounded by a triangular boundary with rounded corners). As shown, the portions may include a Safety and Sensors portion 1014, an energy portion 1016, a climate portion 1018, a people portion 1020, a door locks portion 1022, a lights portion 1024, a controls portion 1026, and a cameras portion 1028 (as examples). As shown, in the home screen summary information 1030 may be provided for each portion of the facility being monitored and/or controlled. The home screen may have a header 1012 that indicates the home screen with text such as “Dashboard” in the example of FIG. 10.

As shown, lights portion 1024 may include summary information that shows a number out of a total number of monitored lights at the facility that are turned on (e.g., “3 of 14 turned on”) and controls portion 1026 may include summary information that shows a number out of a total number of monitored controls/switches at the facility that are turned on (e.g., “2 of 3 turned on”).

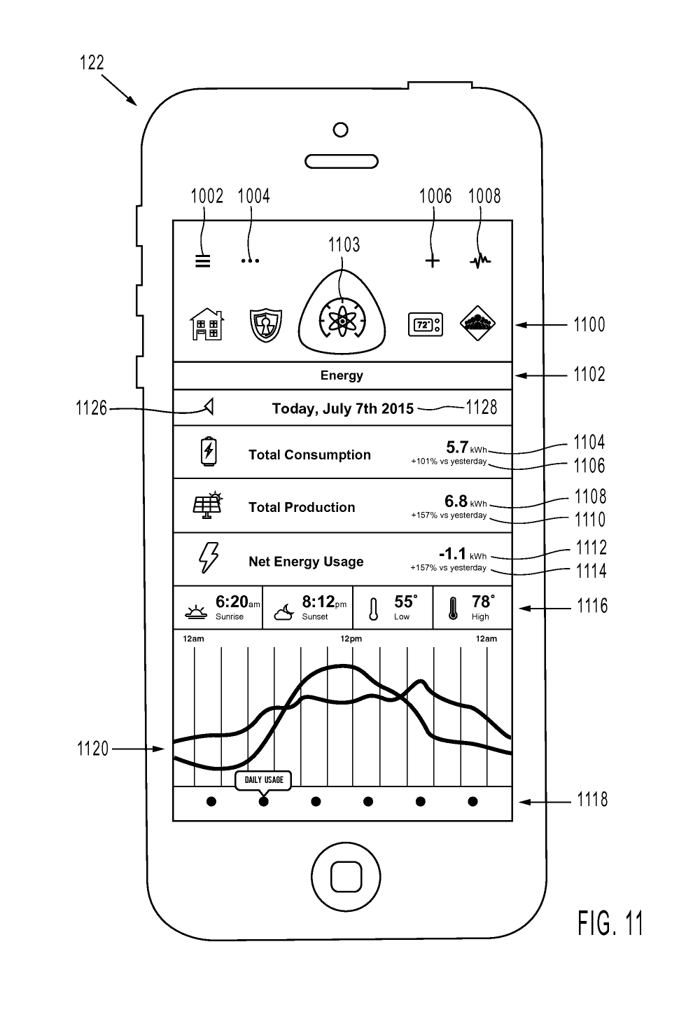

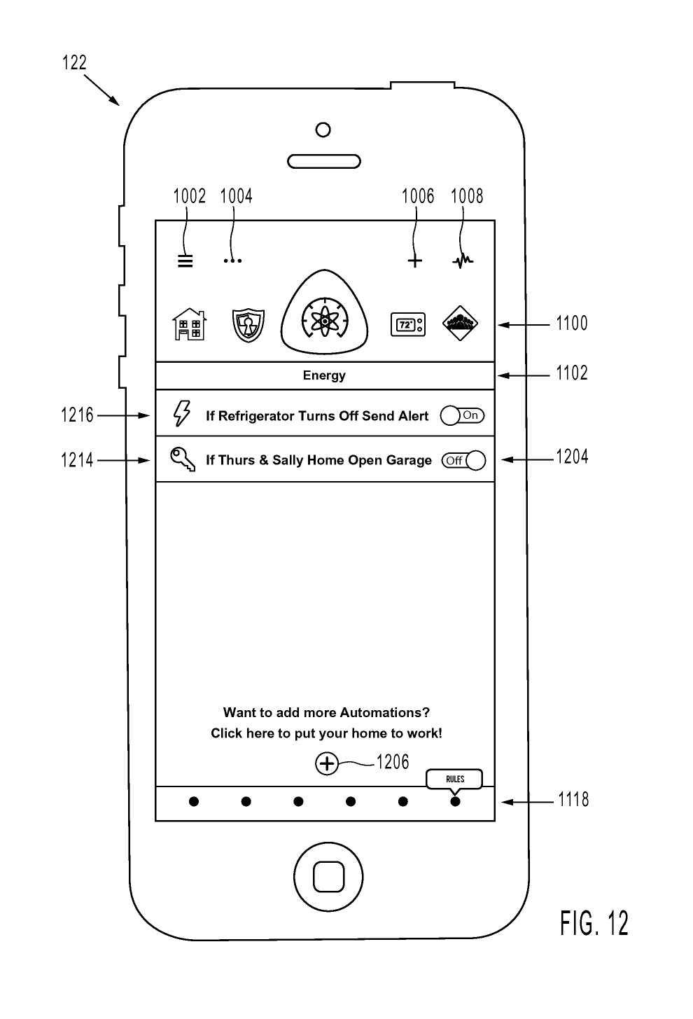

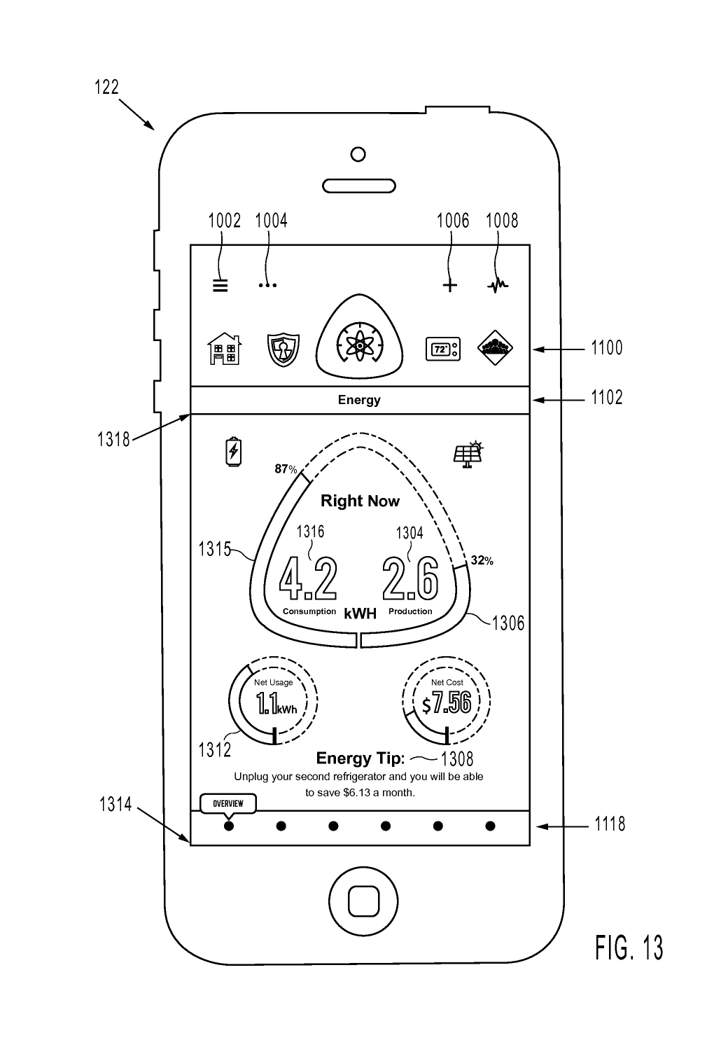

FIGS. 11-13 show various screens associated with monitoring and control of energy portion 1016. As shown in FIG. 11, a first energy monitoring and control screen may include an energy indicator 1100 with an energy icon 1103, a header 1102 (e.g., having text stating “Energy” to indicate an energy portion screen), a date 1128, a date change button 1126, a total consumption section 1104 having total energy consumption values 1106 for the date shown and a comparison with a previous date such as yesterday, a total production section 1108 having total energy production values 1110 for the date shown and a comparison with a previous date such as yesterday, a net energy usage section 1112 having total net energy used values 1114 for the date shown and a comparison with a previous date such as yesterday, an information section 1116 (e.g., showing the sunrise time, sunset time, high temperature and low temperature for the date shown), and a real time energy consumption and production graphs section 1120. An indicator bar 1118 may indicate which screen within the energy portion is being displayed (e.g., a daily usage screen in the example of FIG. 11). By, for example, swiping left or right on the energy screen of FIG. 10, the user may access other energy portion screens such as the rules screen shown in the example of FIG. 12 or the overview screen shown in the example of FIG. 13.

In the example of FIG. 12, another energy portion screen is shown having the energy indicator 1100 and header 1102 and additional information such as rules 1214 and 1216. Rules 1214 and 1216 may be automatically generated (e.g., default or system learned) rules or may be user generated rules and may be displayed in symbols and/or in text. As shown, rule 1214 includes time and people conditions with an associated action (e.g., “IF it is Thursday evening and Sally comes home THEN open the garage door”). In this way, access to a managed facility may be controlled based on a time and a user location.

Rule 1216 includes a device condition and an associated action (e.g., “IF the refrigerator turns off THEN alert me”). In this way, a user may be alerted if a device failure condition occurs. As shown in FIG. 10, an add icon 1206 may be provided to the user that, when selected, provides the user with the ability to add more automation rules similar to rules 1214 and 1216 for the energy portion or any other portion of the managed facility. A toggle switch 1204 may be provided for each rule to activate or inactivate that rule. The rules shown in FIG. 12 are merely illustrative and a user may be provided with the ability to generate rules for monitoring and control of any portion of a facility such as rules for turning on and/or off devices/appliances, locking or unlocking doors/windows to provide access or otherwise modifying the operation of one or more devices/appliances at a managed facility.

As shown in FIG. 13, in another energy portion screen, a user may be provided with a real time energy production value 1304 and a real time energy consumption value 1316. Production value 1304 may have an associated indicator bar 1306 that indicates the real time production relative to the maximum production for the system. Consumption value 1316 may have an associated indicator bar 1315 that indicates the real time consumption relative to the maximum consumption for the system. A total consumption or production for a particular time period such as a day may be displayed using an indicator 1312, associated text (e.g., a net usage and/or a net cost display) and additional messages such as a savings encouragement or energy tip message 1308 may also be provided. The area of the screen between a top portion 1318 and a bottom portion 1314 may be used to swipe between screens within a particular monitoring and control portion.

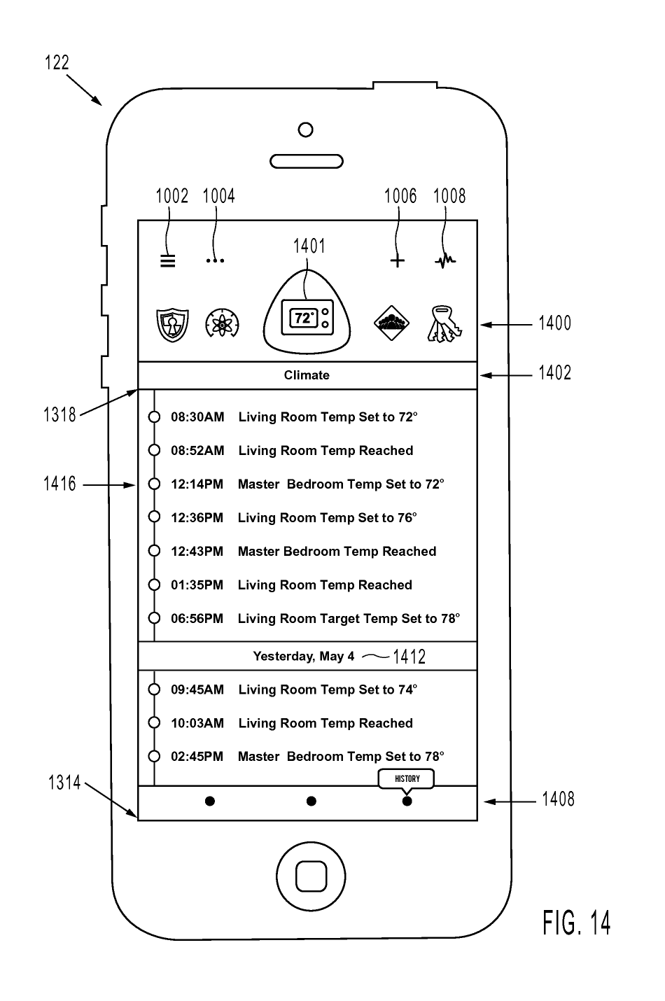

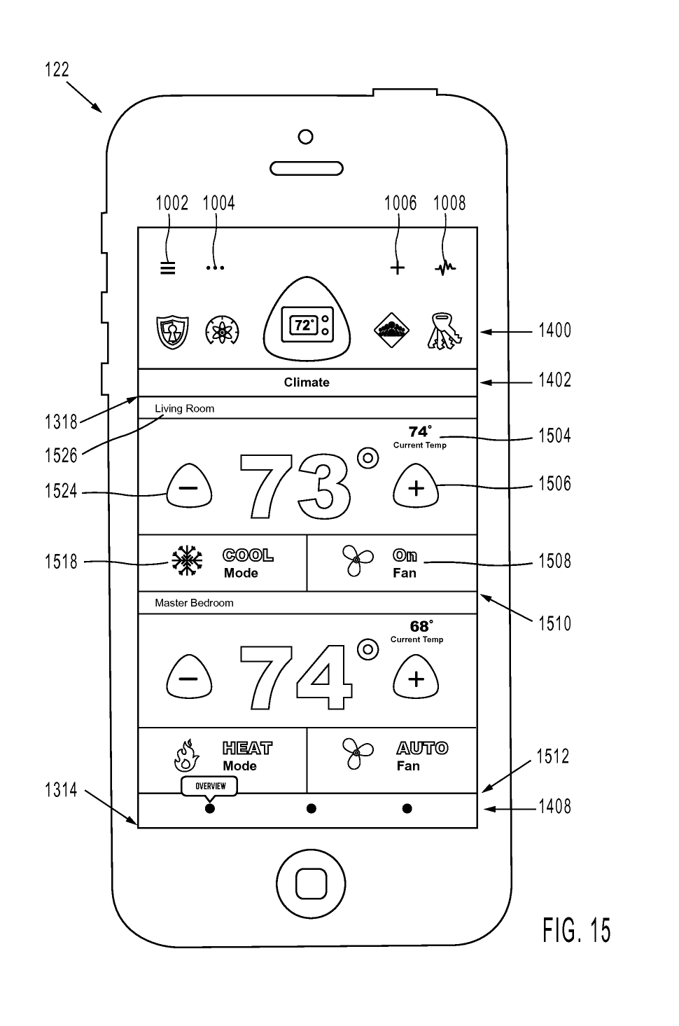

FIGS. 14 and 15 show various screens associated with monitoring and control of climate portion 1018. As shown in FIG. 14, a climate monitoring and control screen may include a climate indicator 1400 with an climate icon 1401, a header 1402 (e.g., having text stating “Climate” to indicate a climate portion screen), a listing 1416 of climate status changes for various devices or portions of a facility (e.g., changes in target or actual temperature in one or more zones of a facility such as a living room zone or a master bedroom zone) along with times for each change. The listing 1416 may be displayed in sections separated by date indicators such as date indicator 1412. An indicator bar 1408 may indicate which screen within the climate portion is being displayed such as the history screen of the example of FIG. 14.

FIG. 15 shows another climate screen providing additional climate monitoring and control information for a facility including a current temperature 1504, a temperature increase button 1506, an HVAC fan toggle (e.g., on/off) button 1508, an HVAC mode selector 1518, a target temperature 1522, a temperature decrease button 1524 and a zone indicator 1526 for a first zone 1510 (e.g., a “Living Room” zone). As shown, similar monitoring and control information may be provided for other zones such as a “Master Bedroom” zone 1512.

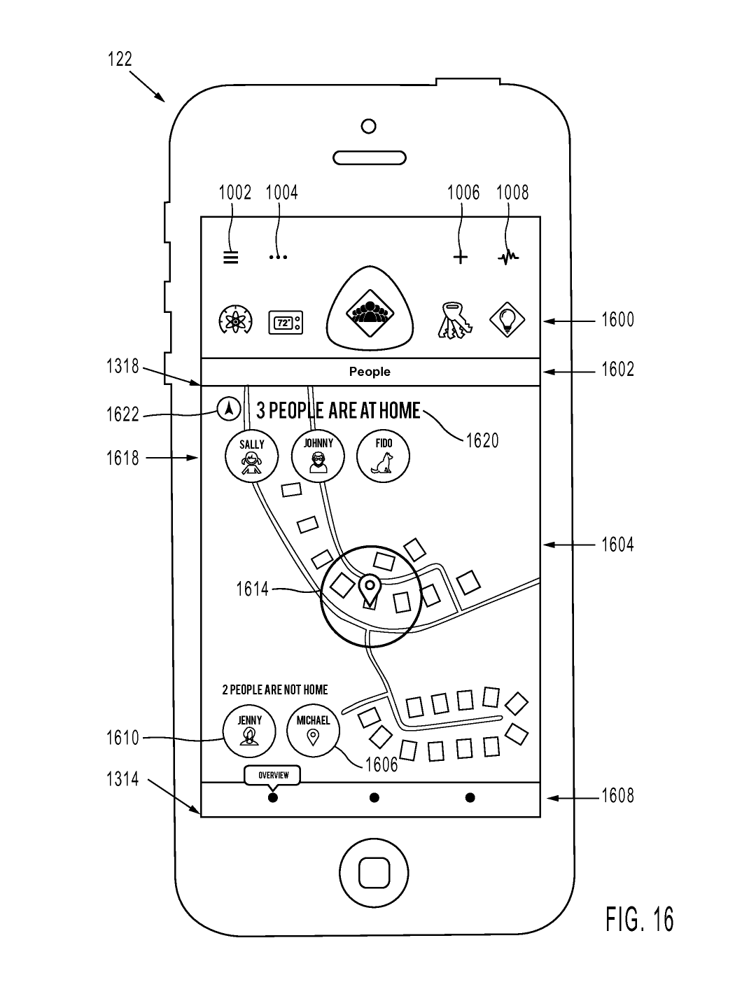

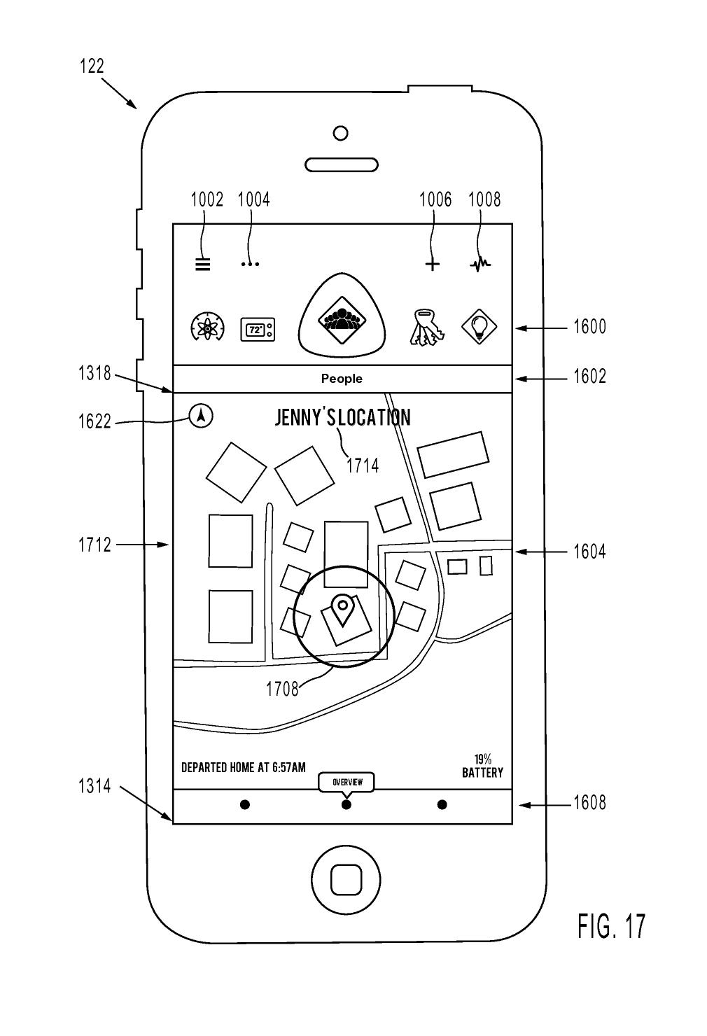

FIGS. 16 and 17 show various screens associated with monitoring and control of people portion 1020. As shown in FIG. 16, a people monitoring and control screen may include a people indicator 1600 with a people icon 1601, a header 1602 (e.g., having text stating “People” to indicate a people portion screen), a map 1604 with a hub location indicator 1614, icons 1618 for each person at the facility (e.g., occupants such as “Sally”, “Johnny”, and “Fido”), icons 1606 and 1610 for people associated with the facility that are not at the facility (e.g., facility users that are not currently occupants such as “Jenny” and “Michael”). The locations of the user may be determined based on communication (e.g., proximity based communication) between user devices of each user and the hub at the facility and/or location information (e.g., global positioning system (GPS) information) provided from the user's device to the hub or a server such as server 140 (see FIG. 1). As shown in FIG. 16, an indicator 1620 may be provided that indicates the number of occupants at the facility (e.g., the number of people “at home”) and a zoom button 1622 may be provided that centers and zooms map 1604 on the location of the facility (e.g., the location of the hub). For example, if the map has been zoomed or moved by the used (e.g., by swiping or pinching the map using a touchscreen), zoom button 1604 may return the map to the hub location. An indicator bar 1608 may indicate which screen within the climate portion is being displayed.

A particular icon such as icon 1606 for a user that is away from the facility may be tapped to obtain a screen specific to that user's location as shown in FIG. 17. As shown in FIG. 17, an away user's people screen may show text 1714 indicating which user (e.g., “Jenny's Location”) and a map 1712 centered on the location of that user as indicated by a user location indicator 1708.

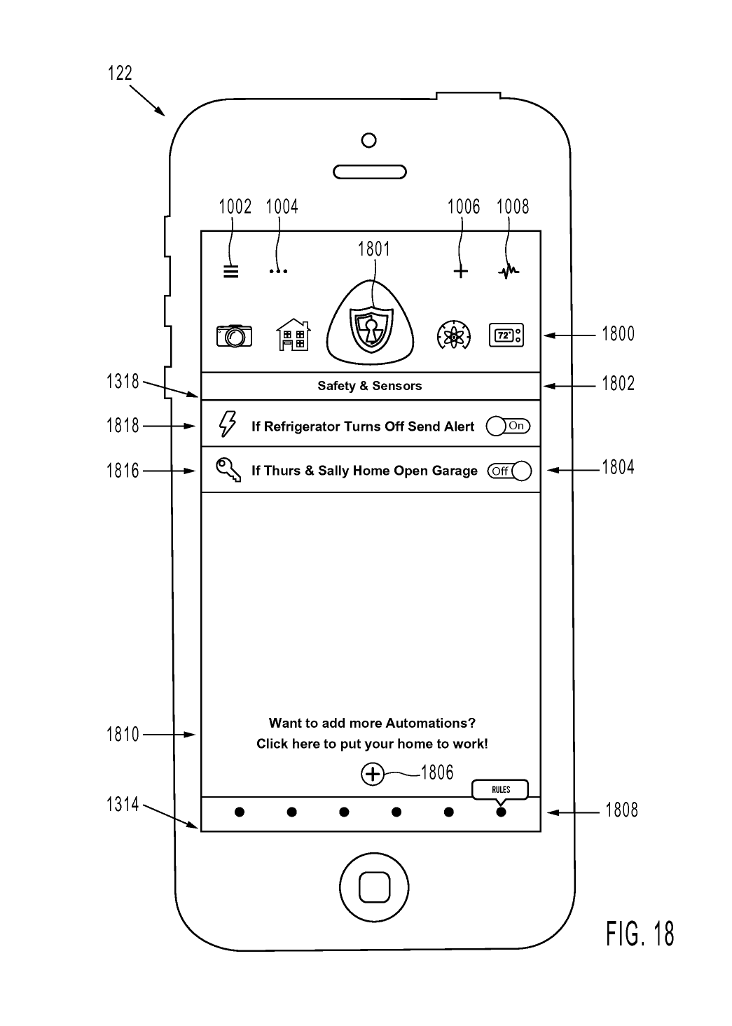

FIG. 18 shows a screen associated with monitoring and control of Safety and Sensors portion 1014. As shown in FIG. 18, a Safety and Sensors monitoring and control screen 1810 may include a Safety and Sensors indicator 1800 with a Safety and Sensors icon 1801, a header 1802 (e.g., having text stating “Safety & Sensors” to indicate a Safety and Sensors portion screen), and additional information such as rules 1816 and 1818 and associated toggle switches for activating or deactivating the rules such as toggle switch 1804. Rules 1816 and 1818 may be automatically generated (e.g., default or system learned) rules or may be user generated rules and may be displayed in symbols and/or in text. An indicator bar 1808 may indicate which screen within the Safety and Sensors portion is being displayed. An add-automation button 1806 may also be provided for initiating generation of new automation rules. Various rules related to user locations and times may be generated to provide a digital key to a facility for various users that can be managed by one or more administrators of a monitoring and control system for the facility.

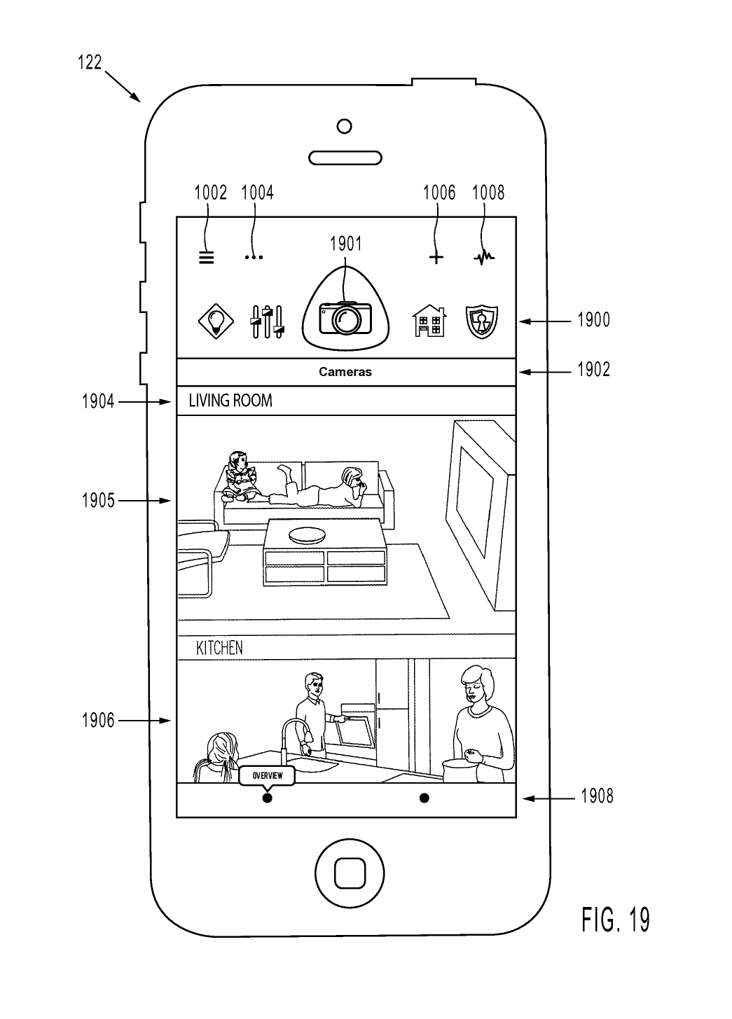

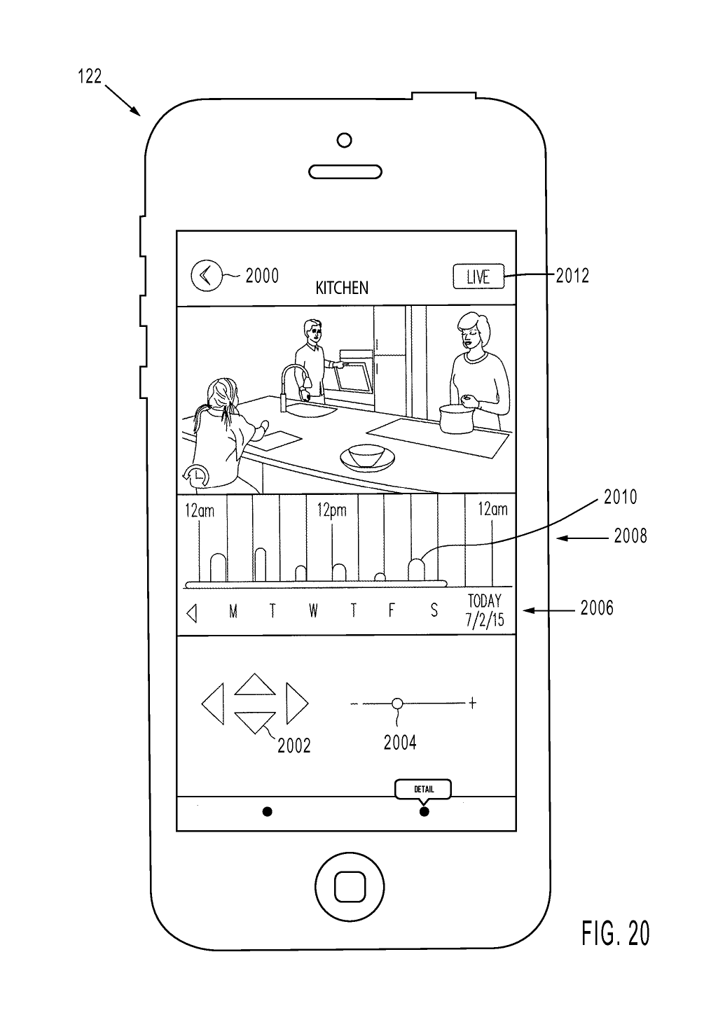

FIGS. 19 and 20 show various screens associated with monitoring and control of cameras portion 1028. As shown in FIG. 19, a camera monitoring and control screen may include a camera indicator 1900 with a camera icon 1901, a header 1902, a camera location indicator 1904 (e.g., “Living Room”) for a first camera view 1905, and a second camera view 1906, and may be scrollable to view any other additional cameras in other rooms or zones of a facility such as a home. An indicator bar 1908 may indicate which screen within the cameras portion is being displayed.

If, for example, camera feed 1906 is selected, a live feed from that camera may be provided as shown in FIG. 20. Camera controls may be provided for the live camera feed such as controls 2002 for moving the camera in various directions (e.g., up, down, left, or right) and control 2004 for physically and/or electronically zooming the camera feed. Additional information associated with a video feed may also be provided such as a selectable date indicator 2006 and a timeline 2008 showing motion detection event indicators 2010. Motion may be detected by the system (e.g., by hub computing equipment that receives a video feed from one or more cameras and/or by a server that receives a video feed via the hub) and detected motion events may be stored and associated indicators 2010 generated to provide to a user device. An indicator 2012 may be provided that indicates a live video feed in the example of FIG. 20 or a recorded video feed. A back button 2000 may be provided for returning to the main camera screen shown in FIG. 19.

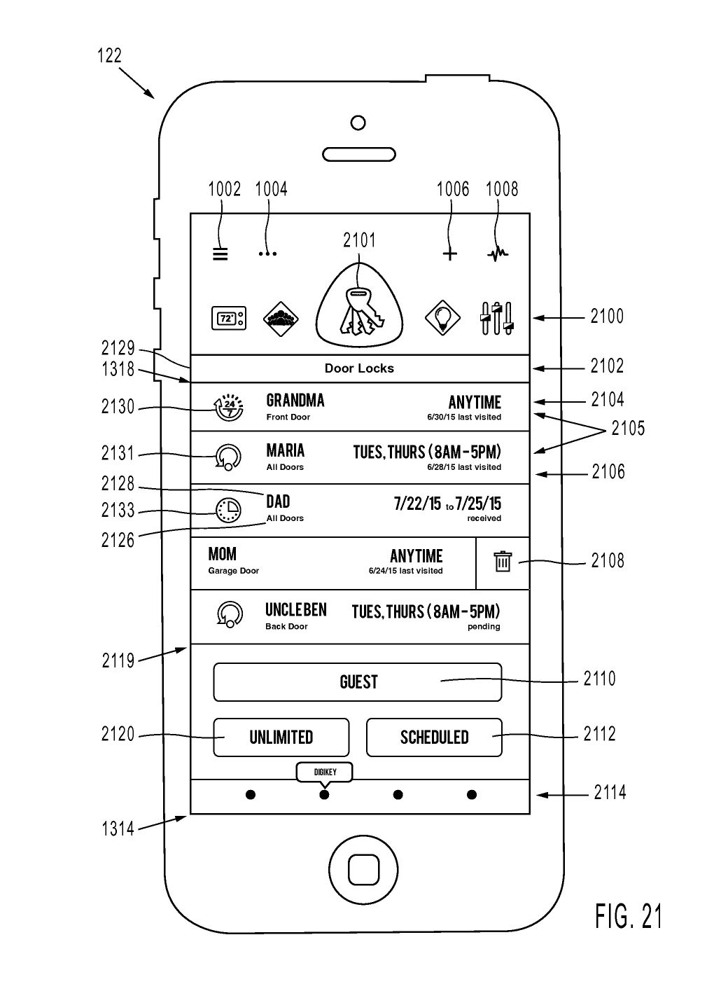

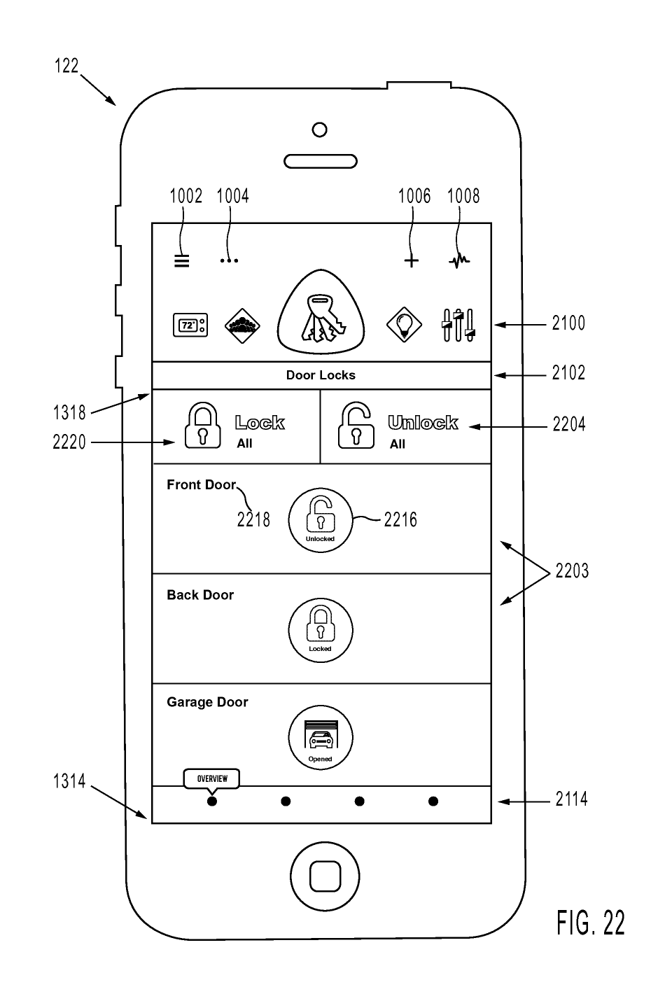

FIGS. 21 and 22 show various screens associated with monitoring and control of door locks portion 1022. As shown in FIG. 21, a door locks monitoring and control screen may include a door locks indicator 2100 with a door locks icon 2101, a header 2102 (e.g., having text stating “Door Locks” to indicate a door locks portion screen), and one or more access rules 2105. As shown, each access rule may include an access-type icon 2130, an identifier 2128 (e.g., a name) of the person who is provided access, an access point indicator 2126 indicating which access points (e.g., “All Doors”, “Front Door”, or “Garage Door”) the identified person has access to, and a time indicator 2104 indicating one or more time periods for which the identified person has access at the identified access points. Providing access may include providing a digital key to the identified person's mobile device that, when the device is detected in proximity to an identified access point in the identified time period, unlocks and/or opens the access point to provide the access.

As shown, access-type icons 2130 may include an “always” icon 2130 that indicates full time access, a “scheduled” icon 2131 that indicates scheduled or periodic access (e.g., every Tuesday and Thursday from 8 am to 5 pm), and a visitor icon 2133 that indicates a temporary access such as access for a visiting guest for a period of hours, days, weeks, months, etc. Additional information such as access history information 2106 showing the last time each identified person accessed the facility may also be provided.

Additional controls such as controls 2108, 2110, 2112, and 2120 may be provided for deleting (control 2108), modifying and/or adding an access rule. For example, guest button 2110 may be provided for adding access rule 2119 as a guest access or modifying an existing access rule 2119 to a guest rule. A scheduled button 2112 may be provided for adding access rule 2119 as a scheduled access or modifying an existing access rule 2119 to a scheduled access rule. An unlimited button 2120 may be provided for adding access rule 2119 as an unlimited access or modifying an existing access rule 2119 to an unlimited rule. An indicator bar 2114 may indicate which screen within the door locks portion is being displayed.

As shown in FIG. 22, an additional door locks screen may include controls for remotely controlling any or all access points at a managed facility real time. For example, a door locks screen may include a lock all button 2220 that, when selected, locks all remotely controllable access points at the facility, an unlock all button 2204 that, when selected, unlocks all remotely controllable access points at the facility, and/or one or more individual access point controls 2203 each having an access point label 2218 and a status indicator 2216 that indicates whether that labeled access point is locked or unlocked. The status indicator 2216 may serve as a control button that, when selected (e.g., tapped) toggles the access point from locked to unlocked or from unlocked to locked (e.g., by transmitting a control signal to a hub, directly or via a server, that provides a corresponding control signal to a mechanical or electrical access control device that locks or unlocks the access point responsive to the received control signal from the hub).

The exemplary application screen shots of FIGS. 10-22 illustrate various ways in which a user, via interaction with an application running on their user device, may monitor and/or control aspects of a managed facility such as their home or business. More particularly, the application may provide the user with the ability to enter settings and relatively complicated and sometimes overlapping rules for automatic management of the facility that, when a server receives energy usage information from the facility, are used, in various embodiments, to generate instructions to be provided to a hub at the facility for operating and/or modifying the operation of various devices and/or appliances and/or access points at the facility to comprehensively manage energy and security for the home while reducing energy usage and cost and maintaining needed and desired services for occupants of the facility.

Although various control switches and buttons shown and described above are described in the context of virtual (e.g., touchscreen) controls, this is merely illustrative and it should be appreciated that mechanical buttons or switches of a user device may be repurposed or provided with dedicated functionality for performing any or all of the operations described herein.

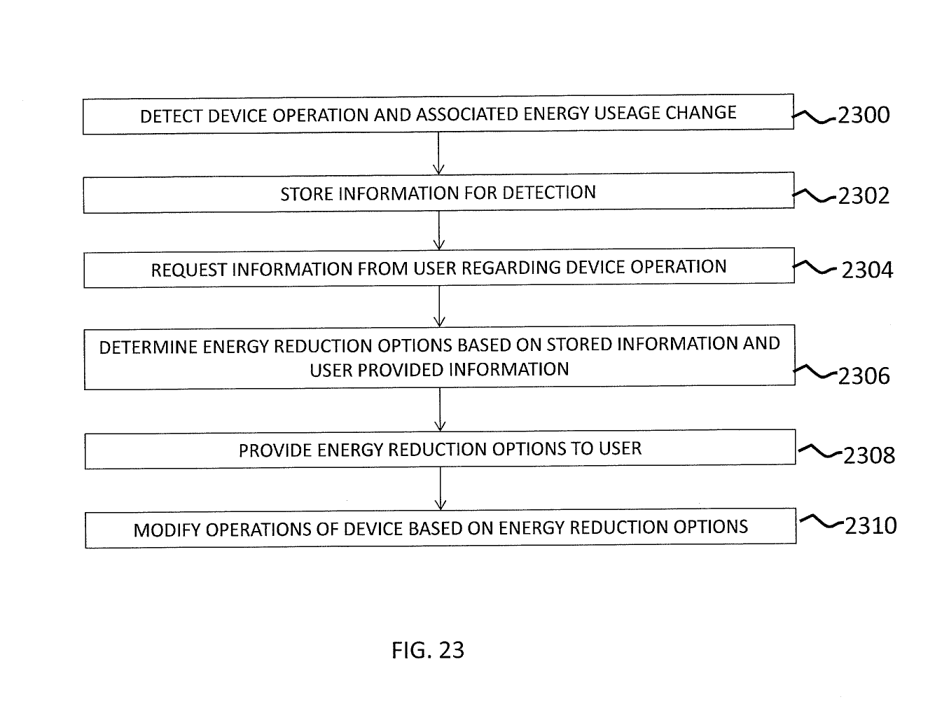

In some embodiments, a system such as system 100 of FIG. 1 may be provided with learning functionality in which, following installation of the system at a facility learns various energy usage signatures and scheduling patterns for the facility and/or the users of the facility. Illustrative operations that may be performed for learning operations for a monitoring and control system for a managed facility are shown in FIG. 23.

At block 2300, a device operation and an associated energy usage change may be detected. For example, a user may turn on a light switch in their home. The light switch may provide a signal to a hub at the home that the switch was turned on. The hub may also receive an energy feed that includes an associated change in energy usage for the home.

At block 2302, information for the detection may be stored (e.g., at the hub or at a server in communication with the hub).

At block 2304, a request from the user for information regarding the device operation may be provided to the user. For example, a notification may be provided to a user device that the system detected a switch being turned on. The notification may include a query to the user as to what devices are coupled to the switch. For example, the user may report that four incandescent light bulbs are activated when that particular switch is turned on.

At block 2306, energy reduction options may be determined (e.g., by the server) based on stored information and user provided information. For example, the server may compute a usage and/or cost difference for the user if the light sources were to be operated at a reduced intensity, turned on later in the day, or if the light sources were to be replaced with more efficient light sources such as fluorescent or light-emitting-diode (LED) light sources.

At block 2308, the energy reduction options may be provided to the user.

At block 2310, operations of the device may be modified based on the energy reduction options. For example, power to the light bulbs may be reduced to 60% over a period of time that prevents noticeable disruption to the occupants of the facility (e.g., as a default modification or responsive to received permission from the user to reduce the intensity in response to the provided options).

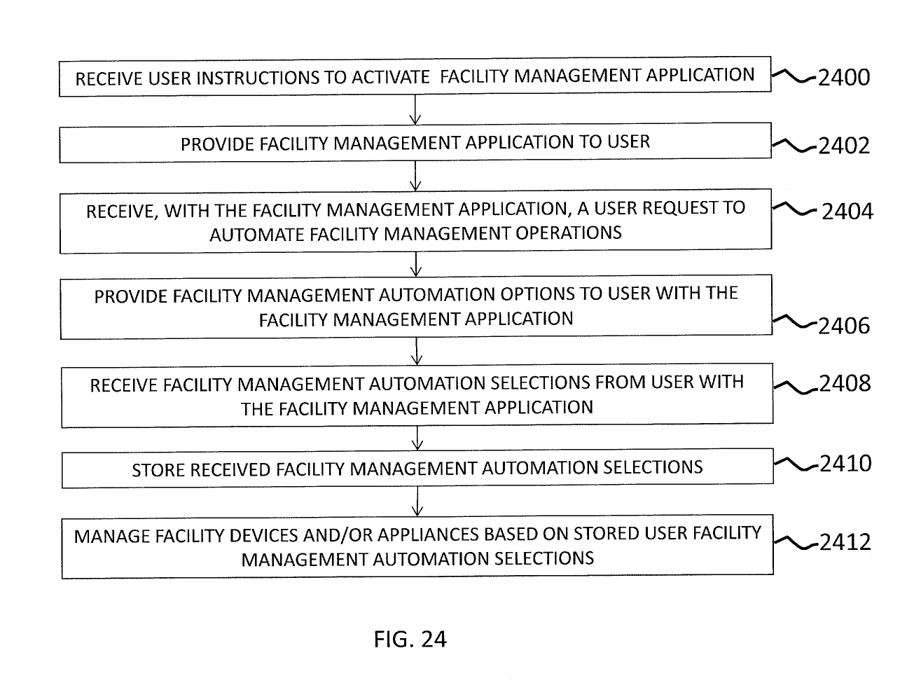

Illustrative operations that may be performed for in-application automation of monitoring and control of a managed facility are shown in FIG. 24.

At block 2400, user instructions to activate a facility management application may be received (e.g., when a user of a user device taps an application icon on their mobile device).

At block 2402, the requested facility management application may be provided to the user. For example, a sign-in screen or the home screen shown in FIG. 10 may be provided to the user.

At block 2404, a user request may be received, with the facility management application, to automate facility management operations. For example, the user may select an automation icon provided by the application.

At block 2406, facility management automation options may be provided to user with the facility management application. For example, access automation, energy management automation, camera automation, climate management automation, lighting automation, and/or switch automation options may be provided to the user. Automation options may include options to set triggers for automated action. Trigger options may include options to set one or more triggers based on a time, a device status, energy usage levels, energy production levels, net energy usage and/or production amounts, facility occupancy status, mood status, and/or a temperature (as examples).

At block 2408, facility management automation selections may be received from the user with the facility management application. For example, the user may generate rules such as the rules described above in connection with FIG. 12. For example, each rule may include one or more triggers (e.g., IF energy production falls below a threshold value and IF energy consumption exceeds another threshold value) and one or more actions to be taken in response to the triggers (e.g., cycle the HVAC system).

At block 2410, the received facility management automation selections may be stored (e.g., by the hub and/or the server).

At block 2412, facility devices and/or appliances may be managed based on the stored user facility management automation selections as described herein in connection with the various embodiments for monitoring and control of a managed facility. For example, actions may be taken to modify the operation of one or more devices/appliances (e.g., including in some embodiments cameras, door locks, window locks, etc.) when associated triggers are detected by the system (e.g., by a hub at the facility and/or a server in communication with the hub).

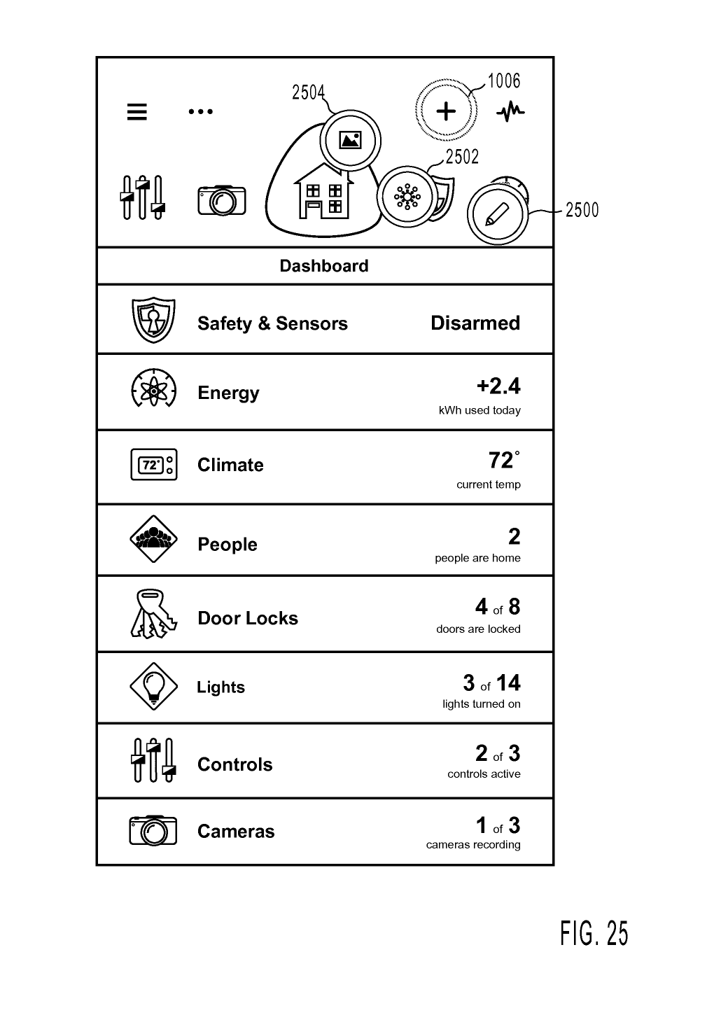

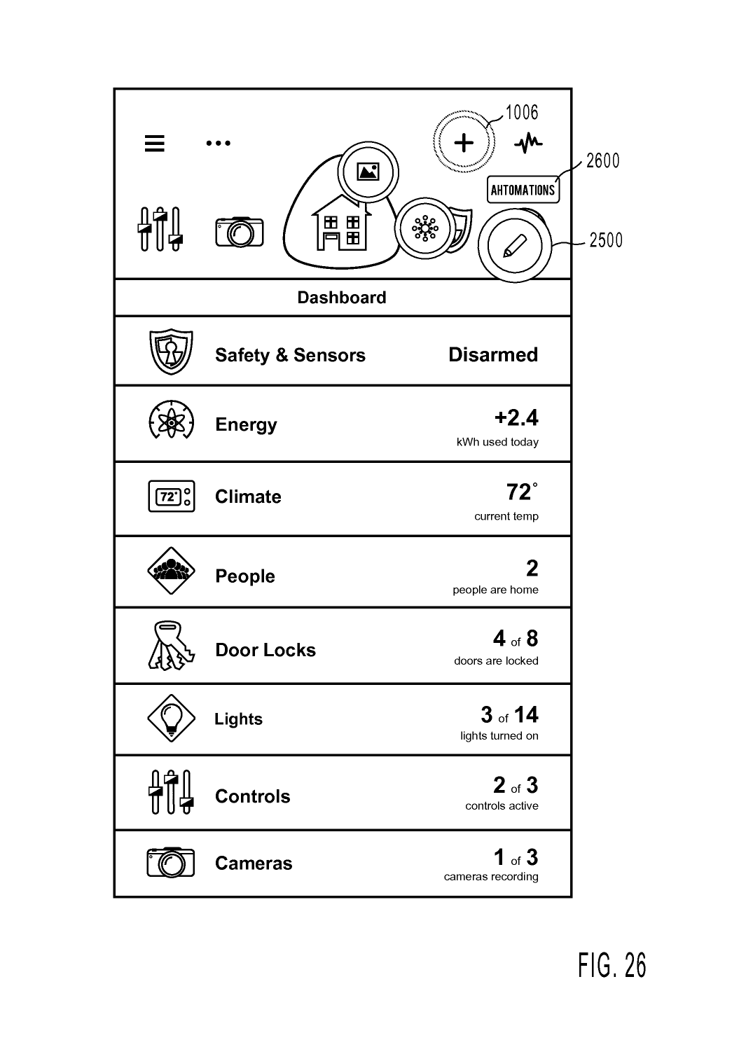

Illustrative screenshots of application screens for initiating automation are shown in FIGS. 25 and 26. As shown in FIG. 25, if a user selects (e.g., taps) setup icon 1006, one or more setup buttons such as buttons 2500, 2502, and 2504 may be provided. Selection of automation button 2500 may result in an “ahtomations” icon 2600 and associated setup options being provided to the user as shown in FIG. 26. Selection of devices button 2502 may result in a device setup icon and associated setup options being provided to the user. Selection of mood button 2504 may result in a mood setup icon and associated setup options being provided to the user.

The foregoing is merely illustrative of the principles of this invention and various modifications can be made by those skilled in the art without departing from the scope and spirit of the invention.

What is claimed is:

1. A system, comprising:
hub computing equipment at a managed facility that includes at least one electronic device, wherein the hub computing equipment includes processing circuitry configured to generate control signals for operating the at least one electronic device; and
a server that includes processing circuitry configured to:
receive energy usage information for the managed facility from the hub computing equipment;
extract device usage information for the at least one electronic device from the received energy usage information;
generate instructions for operating the at least one electronic device based on the extracted device usage information; and
provide the generated instructions to the hub computing equipment.

2. The system of claim 1, wherein the at least one electronic device comprises a plurality of appliances and other devices and wherein the hub computing equipment and the server are configured to cooperate to manage total energy consumption by the managed facility by controlling operation of the plurality of appliances and other devices based on the energy usage information received by the hub from a meter at the managed facility.

3. The system of claim 1, wherein the hub computing equipment is configured to:
receive the generated instructions from the server;
translate the generated instructions to form the control signals for operating the at least one electronic device; and
operate the at least one electronic device by providing the control signals to the at least one electronic device.

4. The system of claim 3, wherein the at least one electronic device comprises a plurality of light sources and wherein the instructions comprise instructions to reduce an intensity of at least one of the plurality of light sources.

5. The system of claim 3, wherein the at least one electronic device comprises one or more components of a heating ventilation and air conditioning system and wherein the instructions comprise instructions to cycle power to the one or more components of the heating ventilation and air conditioning system.

6. The system of claim 3, wherein the at least one electronic device comprises a plurality of electronic devices and wherein the server processing circuitry is further configured to:
determine priorities for the plurality of electronic devices; and
generate the instructions for operating the at least one electronic device by generating instructions for operating the plurality of electronic devices based on the extracted device usage information and the determined priorities.

7. The system of claim 3, wherein the at least one electronic device comprises an appliance and wherein the instructions comprise instructions to prevent startup of the appliance.

8. The system of claim 1, wherein the server is configured to generate the instructions for operating the at least one user device based on the extracted device usage information and additional information.

9. The system of claim 8, wherein the additional information comprises information selected from the group consisting of: device priority information, user rule information, facility occupancy information, utility alert information, rate information, and cost information.

10. The system of claim 1, further comprising a control device coupled to a window or a door of the managed facility and wherein the instructions comprise instructions to open or close the window or the door using the control device.

11. The system of claim 1, further comprising a control device coupled to a door of the managed facility and wherein the hub computing equipment is further configured to operate the control device to selectively provide access to the managed facility for a user based on a time and an identity of the user.

12. The system of claim 1, further comprising a camera at the managed facility, wherein the hub computing equipment is configured to provide images from the camera to a user device.

13. The system of claim 1, further comprising the managed facility and the at least one electronic device, wherein the managed facility comprises a meter that monitors energy consumption at the managed facility, wherein the at least one electronic device comprises at least one device having an energy monitor, and wherein the energy usage information comprises energy consumption information from the meter and additional device usage information from the energy monitor.

14. A method, comprising:
with hub computing equipment at a managed facility that includes at least one electronic device, generating control signals for operating the at least one electronic device;
with a server in communication with the hub computing equipment, receiving energy usage information for the managed facility from the hub;
with the server, extracting device usage information for the at least one electronic device from the received energy usage information;
with the server, generating instructions for operating the at least one electronic device based on the extracted device usage information; and
with the server, providing the generated instructions to the hub computing equipment.

15. The method of claim 14, further comprising:
with the hub computing equipment, receiving the generated instructions from the server;
with the hub computing equipment, translating the generated instructions to form the control signals for operating the at least one electronic device; and
with the hub computing equipment, operating the at least one electronic device by providing the control signals to the at least one electronic device.

16. The method of claim 15, wherein the receiving comprises receiving a gross energy usage feed from a meter and individual device usage information from associated individual device monitors and wherein the extracting comprises:
removing an individual device usage contribution from the gross energy usage feed based on the individual device usage information; and
determining usage information for additional devices based on the gross energy usage feed.

17. The method of claim 15, further comprising determining a high energy usage state based on the energy usage information, wherein the operating comprises reducing an intensity of a light source at the managed facility.

18. The method of claim 15, further comprising determining a high energy usage state based on the energy usage information, wherein the operating comprises cycling a heating, ventilation, and air conditioning system at the managed facility.

19. The method of claim 15, further comprising:
determining a cost of energy usage for the managed facility;
storing rate increase triggers for the managed facility; and
wherein the generating comprises generating the instructions for operating the at least one electronic device based on the extracted device usage information, the cost of energy usage, and the rate increase triggers.

20. A method, comprising:
providing a facility management application to a user of a user device with a processor of the user device;
receiving, with the facility management application, a request to automate facility management operations for a managed facility;
providing, with the facility management application, a plurality of automation options to the user, wherein the automation options each include at least one trigger, and at least one action associated with the at least one trigger;
receiving, with the facility management application, selected ones of the plurality of automation options from the user;
storing, with a memory of a server, the selected ones of the plurality of automation options from the user; and
operating, with a hub at the managed facility and based on the stored selected ones of the plurality of automation options from the user, one or more devices at the managed facility.

21. The method of claim 20, further comprising:
with the hub, providing energy usage information to the server;
with the server, generating instructions for the operating based on the energy usage information and the stored selected ones of the plurality of automation options; and
providing the instructions from the server to the hub.

22. The method of claim 21, wherein the at least one trigger comprises a trigger based on a time, a device status, an energy usage level, an energy production level, a facility occupancy status, a mood status, or a temperature.

23. The method of claim 20, wherein the one or more devices comprise an appliance and a door lock and wherein the operating comprises:
modifying operation of the appliance based on the energy usage information; and
operating the door lock to provide access to an additional user based on the stored selected ones of the plurality of automation options.
